(19) United States
(12) Patent Application Publication
(10) Pub. No.: US 2022/0119682 A1
(43) Pub. Date: Apr. 21, 2022

(54) RECORDING PAPER, USE THEREOF, AND METHOD FOR PRODUCING RECORDING PAPER

(71) Applicant: YUPO CORPORATION, Tokyo (JP)

(72) Inventors: Yutaro SUGAMATA, Ibaraki (JP); Ryota TOYAMA, Ibaraki (JP)

(73) Assignee: YUPO CORPORATION, Tokyo (JP)

(21) Appl. No.: 17/421,121

(22) PCT Filed: Jan. 10, 2020
(86) PCT No.: PCT/JP2020/000773

§ 371 Date: Jul. 7, 2021

(30) Foreign Application Priority Data
Jan. 11, 2019 (JP) 2019-003722
Jan. 11, 2019 (JP) 2019-003775
Jan. 11, 2019 (JP) 2019-003851

(51) Int. Cl. C09J 7/29; C09J 11/04; C09J 7/38; B32B 27/08; B32B 7/12; B32B 27/20; B32B 27/32; B32B 27/16; B65D 25/20; G09F 3/02; G09F 3/10; G09F 3/00

(52) U.S. Cl. CPC C09J 7/29; G09F 2003/0201; C09J 7/38; B32B 27/08; B32B 7/12; B32B 27/20; B32B 27/32; B32B 27/16; B65D 25/205; G09F 3/02; G09F 3/10; G09F 3/0291; C09J 2203/334; C09J 2433/006; C09J 2479/026; B32B 2255/10; B32B 2255/26; B32B 2519/00; B32B 2307/516; B32B 2307/518; B32B 2270/00; G09F 2003/0255; G09F 2003/0258; G09F 2003/023; C09J 11/04

(57) ABSTRACT

A recording paper includes: a laminated resin film including a substrate composed of a thermoplastic resin film and an underlayer disposed on at least one side of the substrate and composed of a thermoplastic resin composition; and a resin coating disposed facing the underlayer of the laminated resin film, wherein the underlayer has an indentation modulus of 50 to 1200 MPa, the resin coating contains a resin that is a reaction product of a cationic water-soluble polymer and a silane coupling agent, a content of a silane coupling agent component is 15 to 60 parts by mass with respect to 100 parts by mass of the cationic water-soluble polymer component in the resin coating, the resin coating is free from thermoplastic resin particles, and a content of an inorganic filler is 9 parts by mass or less with respect to 100 parts by mass of the cationic water-soluble polymer component in the resin coating.

### TECHNICAL FIELD

The present invention relates to recording paper, use thereof, and a method for producing the recording paper.

### BACKGROUND ART

Conventionally, recording paper that is excellent in water resistance, weather resistance, and durability has been proposed as various recording paper such as printing paper, poster paper, label paper, ink jet recording paper, heat-sensitive recording paper, thermal transfer receiving paper, pressure-sensitive transfer recording paper, and electrophotographic recording paper. For example, for improving the water resistance and stabilizing the coating layer of the recorded layer, a recording paper for heat transfer having a resin coating formed by applying a coating solution containing olefin copolymer emulsion, followed by drying, has been proposed (for example, see Patent Literature 1).

The same resin coating is also applied to recording paper suitable for other recording methods and has been proposed, for example, as recording paper suitable for the wet electrophotographic printing system using a liquid toner, which have been widely adopted in recent years (for example, see Patent Literature 2). In this recording paper, olefin copolymer particles derived from the emulsion within the surface treatment layer are softened by heating to fuse with the liquid toner, thereby enhancing the adhesion to the liquid toner and the substrate.

Meanwhile, an adhesive film formed by providing a pressure-sensitive adhesive layer on the back surface of a thermoplastic resin film and an in-mold label are proposed as labels for plastic containers (for example, see Patent Literatures 3 and 4).

As such an in-mold label, an in-mold label in which label arrangement is accurate, and the adhesiveness to a formed product is enhanced by providing a heat sealing layer that is thermally fused to a resin container on a substrate layer and softening the heat sealing layer due to the product temperature of a preform or the mold temperature during biaxial stretching blow molding to be fused and adhere to a surface of the formed product by biaxial stretch blow has been proposed, for example.

The in-mold label is generally provided with a printing layer by printing characters, designs, or the like on a surface of the substrate on the opposite side of the heat sealing layer.

### CITATION LIST

### Patent Literature

Patent Literature 1: Japanese Patent Application Laid-Open No. 2002-113959
Patent Literature 2: International Publication No. 2014/092142
Patent Literature 3: Japanese Patent Application Laid-Open No. 2017-159651
Patent Literature 4: Japanese Patent Application Laid-Open No. 2004-136486

### SUMMARY OF INVENTION

### Technical Problem

Although the resin coating composed of the emulsion-type thermoplastic resin composition according to Patent Literature 1 or 2 above has improved the water resistance, it has turned out that there is room for improvement in adhesion between the substrate surface and the resin coating. Further, it has turned out that there is room for improvement in anti-blocking properties during storage of printing paper at high temperature and change in gloss on the printed surface before and after printing in printing systems such as UV curing and heat fixing, or in-mold molding, since emulsion-derived olefin polymer particles are fused to each other due to heat to easily deform the surface shape of the resin coating.

Further, it has turned out that there is room for improvement, since problems such as adhesive residue may occur when an adhesive film is produced by providing a pressure-sensitive adhesive layer on recording paper with the resin coating according to Patent Literature 1 or 2 above formed, in the case where the adhesion strength between the substrate and the resin coating is insufficient.

It is an object of the present invention to provide recording paper, an adhesive label, an in-mold label, and a method for producing recording paper with high adhesion, particularly, high water resistant adhesion, less ink transfer failure and less reduction in ink adhesion of printings, less blocking, and less change in paper quality after printing and forming.

### Solution to Problem

The present invention is as follows.

(1) A recording paper comprising:

a laminated resin film comprising a substrate composed of a thermoplastic resin film and an underlayer disposed on at least one side of the substrate and composed of a thermoplastic resin composition; and

a resin coating disposed facing the underlayer of the laminated resin film, wherein

the underlayer has an indentation modulus of 50 to 1200 MPa,

the resin coating contains a resin that is a reaction product of a cationic water-soluble polymer and a silane coupling agent,

a content of a silane coupling agent component is 15 to 60 parts by mass with respect to 100 parts by mass of the cationic water-soluble polymer component in the resin coating,

the resin coating is free from thermoplastic resin particles, and

a content of an inorganic filler is 9 parts by mass or less with respect to 100 parts by mass of the cationic water-soluble polymer component in the resin coating.

(2) The recording paper according to (1) above, wherein the cationic water-soluble polymer is a (meth)acrylic polymer or an ethyleneimine polymer having an amino group or an ammonium salt structure.
(3) The recording paper according to (2) above, wherein the (meth)acrylic polymer or the ethyleneimine polymer having an amino group or an ammonium salt structure has a primary to tertiary amino group or a primary to tertiary ammonium salt structure.
(4) The recording paper according to any one of (1) to (3) above, wherein the silane coupling agent is an epoxy silane coupling agent.
(5) The recording paper according to any one of (1) to (4) above, wherein the resin coating has a thickness of 0.01 to 5 μm.
(6) A method for producing a recording paper, comprising: applying an aqueous solution containing a cationic water-soluble polymer and a silane coupling agent and being free from thermoplastic resin particles with a content of an inorganic filler being 9 parts by mass or less with respect to 100 parts by mass of the cationic water-soluble polymer onto a laminated resin film, followed by drying to form a resin coating on the laminated resin film, wherein the laminated resin film comprises a substrate composed of a thermoplastic resin film and an underlayer composed of a thermoplastic resin composition and disposed on at least one side of the substrate.
(7) An adhesive label comprising:

a laminated resin film comprising a substrate composed of a thermoplastic resin film, a first underlayer composed of a thermoplastic resin composition and disposed on one side of the substrate, and a second underlayer composed of a thermoplastic resin composition and disposed on the other side of the substrate;

a resin coating disposed facing the first underlayer of the laminated resin film; a resin coating disposed facing the second underlayer of the laminated resin film; and

an adhesive layer disposed on a surface of the resin coating disposed facing the second underlayer on the opposite side of the second underlayer, wherein

the first and second underlayers each have an indentation modulus of 50 to 1200 MPa, the resin coating contains a resin that is a reaction product of a cationic water-soluble polymer and a silane coupling agent,

a content of a silane coupling agent component is 15 to 60 parts by mass with respect to 100 parts by mass of the cationic water-soluble polymer component in the resin coating,

the resin coating is free from thermoplastic resin particles, and

a content of an inorganic filler is 9 parts by mass or less with respect to 100 parts by mass of the cationic water-soluble polymer component in the resin coating.

(8) An in-mold label provided with a heat sealing layer on one side of a laminated resin film, wherein

the in-mold label comprises a resin coating provided on a surface of the laminated resin film on the opposite side of the heat sealing layer,

the laminated resin film comprises a substrate composed of a thermoplastic resin film and an underlayer composed of a thermoplastic resin composition and provided between the substrate and the resin coating,

the underlayer has an indentation modulus of 50 to 1200 MPa, the resin coating contains a resin that is a reaction product of a cationic water-soluble polymer and a silane coupling agent,

a content of a silane coupling agent component is 15 to 60 parts by mass with respect to 100 parts by mass of the cationic water-soluble polymer component in the resin coating,

the resin coating is free from thermoplastic resin particles, and

a content of an inorganic filler is 9 parts by mass or less with respect to 100 parts by mass of the cationic water-soluble polymer component in the resin coating.

(9) The in-mold label according to (8) above, further comprising a resin coating provided on a surface of the heat sealing layer on the opposite side of the laminated resin film, wherein

the resin coating contains a resin that is a reaction product of a cationic water-soluble polymer and a silane coupling agent,

a content of a silane coupling agent component is 15 to 60 parts by mass with respect to 100 parts by mass of the cationic water-soluble polymer component in the resin coating,

the resin coating is free from thermoplastic resin particles, and

a content of an inorganic filler is 9 parts by mass or less with respect to 100 parts by mass of the cationic water-soluble polymer component in the resin coating.

### Advantageous Effects of Invention

The present invention can provide recording paper, an adhesive label, an in-mold label, and a method for producing recording paper with high adhesion, particularly, high water resistant adhesion, less ink transfer failure and less reduction in ink adhesion of printings, less blocking, and less change in paper quality after printing and forming.

### BRIEF DESCRIPTION OF DRAWINGS

FIG. 1 is a sectional view showing a structure of recording paper according to one embodiment of the present invention.

FIG. 2 is a sectional view showing a structure of an adhesive label according to one embodiment of the present invention.

FIG. 3 is a sectional view showing a configuration example of an in-mold label according to one embodiment of the present invention.

FIG. 4 is a sectional view showing another configuration example of the in-mold label according to one embodiment of the present invention.

FIG. 5 is an image capturing a surface of a resin coating in the recording paper of Comparative Example 3.

FIG. 6 is an image capturing a surface of a resin coating of recording paper according to Example 1.

FIG. 7 is an image capturing a surface of a laminated resin film used for the recording paper in Comparative Example 3 and Example 1.

### DESCRIPTION OF EMBODIMENTS

Hereinafter, recording paper of the present invention, use thereof, and a method for producing the recording paper will be described in detail, but the configuration requirement described below is an example as one embodiment of the present invention (representative example) and is not specified by these contents.

In the following description, the term “(meth)acrylic” means both acrylic and methacrylic. The description of “(co)polymer” means both homopolymer and copolymer.

Further, the numerical range represented by “to” means a range containing the numerical values described before and after “to” as the lower limit and the upper limit.

### (Recording Paper)

The recording paper of the present invention includes a laminated resin film, and a resin coating disposed on at least one side of the laminated resin film.

The laminated resin film has a substrate composed of a thermoplastic resin film and an underlayer composed of a thermoplastic resin composition and disposed on at least one side of the substrate.

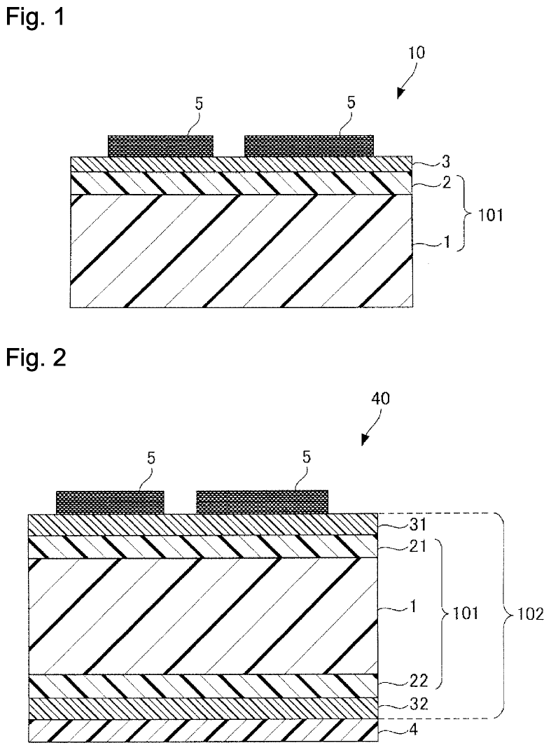

FIG. 1 shows a configuration example of recording paper as one embodiment of the present invention.

As shown in FIG. 1, recording paper 10 includes a laminated resin film 101 having a substrate 1 and an underlayer 2, composed of a thermoplastic resin composition, located on one side of the substrate 1.

Further, the recording paper 10 includes a resin coating 3 disposed facing the underlayer 2 of the laminated resin film 101.

In this description, the laminated resin film and the resin coating disposed on at least one side of the laminated resin film are collectively referred to as recording paper. Specifically, a laminate composed of the resin coating 3 and the laminated resin film 101 (including the underlayer 2 and the substrate 1) in FIG. 1 is referred to as the recording paper 10.

### <Laminated Resin Film>

The laminated resin film has a substrate composed of a thermoplastic resin film and an underlayer composed of a thermoplastic resin composition and disposed on at least one side of the substrate.

### <<Substrate>>

In the present invention, the substrate is composed of a thermoplastic resin film. Use of a thermoplastic resin film as the substrate can impart mechanical strength such as stiffness, water resistance, and chemical resistance, and opacity, etc., as required, to the recording paper or printings using the recording paper.

### <<<Thermoplastic Resin>>>

The thermoplastic resin to be used for the substrate is not specifically limited, and examples thereof include polyolefin-type resins such as polyethylene-type resin, polypropylene-type resin, polybutene, and 4-methyl-1-pentene (co)polymer; functional group-containing olefin-type resins such as ethylene-vinyl acetate copolymer, ethylene-(meth)acrylic acid copolymer, metal salts (ionomers) of ethylene-(meth)acrylic acid copolymer, ethylene-(meth)acrylic acid alkyl ester copolymer (wherein the alkyl group preferably has 1 to 8 carbon atoms), maleic acid-modified polyethylene, and maleic acid-modified polypropylene; polyester resins such as aromatic polyester (such as polyethylene terephthalate, polybutylene terephthalate, and polyethylene naphthalate) and aliphatic polyester (such as polybutylene succinate and polylactic acid); polyamide-type resins such as nylon-6, nylon-6,6, nylon-6,10, and nylon-6,12; styrene resins such as syndiotactic polystyrene, atactic polystyrene, acrylonitrile-styrene (AS) copolymer, styrene-butadiene (SBR) copolymer, and acrylonitrile-butadiene-styrene (ABS) copolymer; polyvinyl chloride resin; polycarbonate resin; and polyphenylene sulfide. Two or more types of these resins can be mixed for use.

Among these, polyolefin resins or polyester resins are preferable because of their high water resistance and high transparency, and ease of formation of a resin coating, which will be described below. In view of film formability, polypropylene resins are further preferable among polyolefin resins, and polyethylene terephthalate is further preferable among polyester resins. The effects of the present invention are remarkable in the case of using polyolefin resins.

Examples of the polypropylene resins include polypropylene copolymers having various stereoregularities obtained by copolymerization of propylene as the main component with α-olefins or the like such as ethylene, 1-butene, 1-pentene, 1-hexene, 4-methyl-1-pentene, 1-heptene, and 1-octene, in addition to isotactic homopolypropylene and syndiotactic homopolypropylene obtained by homopolymerization of propylene. The polypropylene copolymers may be a multi-component system of binary or ternary or more, a random copolymer, or a block copolymer.

### <<<Filler>>>

The substrate can contain a filler for adjusting the rigidity, the whiteness, and the opacity of the substrate. Examples of the filler include inorganic fillers and organic fillers, and these fillers can be used individually or in combination. In the case where a substrate containing a filler is stretched, many micropores with the filler serving as a core can be formed inside the substrate, as a result of which whitening, opacification, and weight reduction can be achieved.

Examples of the inorganic fillers include heavy calcium carbonate, light calcium carbonate, fired clay, talc, diatomite, titanium oxide, zinc oxide, barium sulfate, silicon oxide, magnesium oxide, and inorganic particles obtained by surface-treating these with fatty acid, a polymer surfactant, an antistatic agent, and the like. Among these, heavy calcium carbonate, light calcium carbonate, fired clay, or talc is preferable because of their good formability of pores and low cost. For improving the whiteness and the opacity, titanium oxide, zinc oxide, or barium sulfate is preferable.

The organic fillers are not specifically limited but are preferably organic particles that are immiscible with the thermoplastic resin, have a melting point or a glass transition temperature higher than that of the thermoplastic resin, and are finely dispersed under the melt-kneading conditions of the thermoplastic resin. For example, in the case where the thermoplastic resin is a polyolefin resin, examples of the organic fillers include organic particles of polyethylene terephthalate, polybutylene terephthalate, polyethylene naphthalate, polystyrene, polyamide, polycarbonate, polyethylene sulfide, polyphenylene sulfide, polyimide, polyether ketone, polyetheretherketone, polymethylmethacrylate, poly-4-methyl-1-pentene, a homopolymer of a cyclic olefin, a copolymer of a cyclic olefin and ethylene, and the like. Further, fine powder of a thermosetting resin such as a melamine resin may also be used, and it is also preferable to insolubilize a thermoplastic resin by crosslinking.

The melting point (° C.) and the glass transition temperature (° C.) of the resin can be measured by differential scanning calorimetry (DSC).

One of the inorganic fillers and the organic fillers may be selected from above to be used singly, or two or more of them may be used in combination. In the case of combining two or more types, an inorganic filler and an organic filler may be combined.

The average particle size of the inorganic fillers and the organic fillers are preferably large in view of ease of mixing with the thermoplastic resin. Further, the average particle size of the inorganic fillers and the organic fillers are preferably small in view of reducing troubles such as sheet break in stretching and strength reduction of the substrate in the case of improving the opacity and the printability by forming pores inside the sheet by stretching. Specifically, the average particle size of the inorganic fillers the organic fillers are preferably 0.01 μm or more, more preferably 0.1 μm or more, further preferably 0.5 μm or more. Further, the average particle size of the inorganic fillers and the organic fillers are preferably 30 μm or less, more preferably 20 μm or less, further preferably 15 μm or less.

The average particle size of the inorganic fillers and organic fillers can be determined by observing a cut surface of the substrate using an electron microscope and taking an average in measurement of the maximum diameter of at least 10 particles as an average dispersion particle size when dispersed in the thermoplastic resin by melt-kneading and dispersion.

The content of the fillers in the substrate is preferably 1 mass % or more, more preferably 3 mass % or more, further preferably 5 mass % or more, for imparting opacity, etc., to the substrate.

In view of imparting rigidity to the substrate, thereby improving the handling properties of the recording paper, the content of the fillers in the substrate is preferably 45 mass % or less, more preferably 40 mass % or less, further preferably 35 mass % or less.

### <<<Other Components>>>

In the present invention, the substrate can optionally contain known additives, as required. Examples of the additives include known aids such as antioxidants, light stabilizers, ultraviolet absorbers, crystal nucleating agents, plasticizers, filler dispersants, slip agents such as fatty acid amide, anti-blocking agents, dyes, pigments, mold release agents, and flame retardants. In particular, in the case where the recording paper requires durability as in the case of a poster paper used outdoor, antioxidants, light stabilizers, or the like are preferably contained.

Examples of the antioxidants include steric hindrance phenolic antioxidants, phosphorus antioxidants, and amine antioxidants.

Examples of the light stabilizers include steric hindrance amine light stabilizers, benzotriazole light stabilizers, and benzophenone light stabilizers.

The content of the antioxidants and the light stabilizers to be used is preferably within the range of 0.001 to 1 mass % with respect to the mass of the substrate. Further, the content may be adjusted within a range that does not inhibits the adhesion between the substrate and the underlayer, which will be described below.

In the case of using a polyolefin resin as the thermoplastic resin, the transparency of the substrate can be enhanced by containing a crystal nucleating agent.

Examples of the crystal nucleating agent include sorbitol nucleating agents, phosphoric acid ester metal salt nucleating agents, amide nucleating agents, aromatic metal salt nucleating agents, and talc.

The content of the crystal nucleating agent is preferably 0.01 mass % or more, more preferably 0.05 mass % or more, further preferably 0.1 mass % or more, with respect to the mass of the substrate. Further, the content of the crystal nucleating agent is preferably 1 mass % or less, more preferably 0.5 mass % or less, further preferably 0.3 mass % or less.

In the case of using a polyester resin as the thermoplastic resin, the resin can be plasticized using a plasticizer. Examples of the plasticizer include carboxylic acid esters such as phthalate and adipate; and triacetins.

The substrate may have a single-layer structure or a multilayer structure. For example, the substrate may have a three-layer structure of first surface layer/core layer/second surface layer, and the rigidity, opacity, lightweight properties, and the like suitable for the recording paper can be imparted to the core layer. Here, the types of the components constituting the first surface layer and the second surface layer, the ratios of the structural components, and the thicknesses may be the same or different. Further, not only curling of the substrate can be prevented, but also curling of the recording paper can be controlled to within a specific range, by appropriately designing the composition and thickness of each of the first surface layer and the second surface layer. Further, a solid printing layer or a pigment-containing layer provided inside the first surface layer and the second surface layer as a hiding layer enables the visibility in duplex printing to be improved, without the print on the other surface seen through, as viewed from one side, thereby allowing recording paper suitable as poster paper or the like to be obtained.

Further, the substrate may have a two-layer structure and may be, for example, a substrate having a two-layer structure composed of a core layer and a surface layer (either the first surface layer on the printed surface side or the second surface layer on the side opposite to the printed surface).

The thickness of the substrate is preferably 30 μm or more, more preferably 50 μm or more, for ease of achieving sufficient mechanical strength for use as large poster paper or the like to be posted outside. Further, the thickness of the substrate is preferably 500 μm or less, more preferably 300 μm or less, for reducing the weight of the recording paper and ease of improving the handling properties.

### <<<Porosity>>>

In the case where the substrate has pores therein, the porosity representing the proportion of the pores in the substrate is preferably 10% or more, more preferably 12% or more, further preferably 15% or more, particularly preferably 20% or more, for achieving opacity. For maintaining the mechanical strength, the porosity is preferably 45% or less, more preferably 44% or less, further preferably 42% or less, particularly preferably 40% or less.

The porosity can be measured by determining an area percentage occupied by pores in a certain region of a cross section of the substrate observed using an electron microscope. Specifically, any part of the substrate is cut out and embedded into an epoxy resin, followed by solidification, and the resin is thereafter cut using a microtome perpendicularly to the plane direction of the substrate and attached to an observation table so that the cut surface serves as an observation surface. Gold, gold-palladium, or the like is vapor-deposited onto the observation surface, and the pores are observed at any magnification (for example, a magnification of 500 times to 3000 times) at which observation is easy using an electron microscope, to acquire the region observed as image data. The image data obtained is subjected to image processing using an image analyzer, and the area percentage (%) of the porous part can be determined as a porosity (%). In this case, the measured values at any 10 or more sites in the observation can be averaged and taken as a porosity.

### <<Underlayer>>

In the present invention, the underlayer is composed of a thermoplastic resin composition.

Further, the underlayer has an indentation modulus of 50 to 1200 MPa. The indentation modulus is determined by measurement of the surface side (that is, the surface with the resin coating disposed) of the underlayer by the nanoindentation test, as described below. When the indentation modulus is 50 MPa or more, it is possible to effectively prevent the increase in adhesive force and the occurrence of blocking over time or after heat storage. Meanwhile, when the indentation modulus is 1,200 M or less, it is possible to effectively prevent the reduction in ink adhesion after printing, which will be described below.

In view of above, the indentation modulus is preferably 70 Pa or more, more preferably 100 MPa or more, and preferably 1,000 MPa or less, more preferably 900 MPa or less. Examples of the method for controlling the indentation modulus into a preferable range include a method of controlling the type of the material, the content, the viscoelasticity, and the thickness of the underlayer. For example, the indentation modulus can be adjusted to be low by using various additives such as tackifiers and waxes, which will be described below, and olefin-type resins with a low surface free energy. Further, the indentation modulus can be adjusted to be high by increasing the thickness or the like.

The thermoplastic resin constituting the underlayer is not specifically limited, as long as the effects of the present invention are not impaired, and the same thermoplastic resins as for the substrate can be used.

Among the thermoplastic resins mentioned as materials for the substrate, polyolefin-type resins or functional group-containing olefin-type resins are preferable, and polyolefin-type resins are more preferable, for excellent film processability. Among the polyolefin-type resins, polyethylene-type resins or polypropylene-type resins are preferable, in view of chemical resistance, processability, and cost.

Examples of the polyolefin-type resins include polyethylene-type resins (such as low-density polyethylene, medium-density polyethylene, high-density polyethylene, linear low-density polyethylene, low-crystalline or amorphous ethylene-α-olefin copolymer, and ethylene-cyclic olefin copolymer), polypropylene-type resins (such as crystalline polypropylene, low-crystalline polypropylene, amorphous polypropylene, propylene-ethylene copolymers (including random copolymers or block copolymers), propylene-α-olefin copolymer, and propylene-ethylene-α-olefin copolymer), polybutene, and 4-methyl-1-pentene (co)polymers (such as poly(4-methyl-1-pentene) and 4-methyl-1-pentene-α-olefin copolymer). The α-olefin is not specifically limited, as long as it can copolymerize with ethylene, propylene, or 4-methyl-1-pentene, and examples thereof can include ethylene, propylene, 1-butene, 1-pentene, 1-hexene, 4-methyl-1-pentene, 1-heptene, and 1-octene.

Examples of the functional group-containing olefin-type resin include ethylene-ethyl (meth)acrylate copolymer, ethylene-methyl (meth)acrylate copolymer, ethylene-n-butyl (meth)acrylate copolymer, ethylene-vinyl acetate copolymer, maleic acid-modified polyethylene, and maleic acid-modified polypropylene.

These may be used singly or in combination.

The underlayer may appropriately contain components other than the above such as waxes, tackifiers, lubricants, and other additives as long as the object of the present invention is not impaired. Among these, tackifiers are preferably contained.

As the tackifiers, petroleum resins such as aliphatic copolymers, aromatic copolymers, aliphatic/aromatic copolymers, and alicyclic copolymers, terpene-type resins, terpene-phenolic resins, rosin-type resins, alkyl phenolic resins, xylene-type resins, or hydrogenated products of these can be used, for example. The content of tackifiers in the underlayer is preferably 0.1 mass % or more, preferably 0.2 mass % or more, and preferably 10 mass % or less, more preferably 8 mass % or less.

As the waxes, paraffin waxes, olefin waxes, and modified waxes of these can be used, for example. For example, in the case of olefin waxes, polyethylene waxes, polypropylene waxes, polybutene waxes, or modified waxes of these can be used. The content of waxes in the underlayer is preferably 10 mass % or less. When the content is 10 mass % or less, the reduction in tackiness is easily suppressed.

Examples of the lubricants that can be used include fatty acids, fat acid amides, and fatty acid metal salts having at least one alkyl group or alkenyl group having 4 to 60 carbon atoms, particularly, linear alkyl group or linear alkenyl group having 4 to 30 carbon atoms in a molecule, further specifically, fatty acids such as lauric acid, palmitic acid, stearic acid, behenic acid, oleic acid, and erucic acid, and metal salts or amide compounds of these fatty acids. The content of lubricants in the underlayer is preferably 2 mass % or less, more preferably 1 mass % or less, for reducing bleeding out or the like.

Examples of the other additives include antioxidants, weathering agents, and antistatic agents. These additives may be used singly or in combination.

The thickness of the underlayer is preferably 1 μm or more, more preferably 2 μm or more, for enhancing the adhesion between the laminated resin film and the resin coating. Further, since the thickness of the recording paper is preferably 500 μm or less, for reducing the weight of the recording paper itself to enhance the handleability, the thickness of the underlayer is preferably 200 μm or less, for adjustment to such a range.

An underlayer with an indentation modulus of 50 to 1200 MPa may be disposed on each of both sides of the substrate. For example, in the case where the resin coating is disposed on each of both sides of the substrate, as described below, the underlayer is also preferably disposed on each of both sides of the substrate. In such a case, the types of components constituting the two underlayers and the ratios of the structural components may be the same or different.

### <<Method for Producing Laminated Resin Film>>

The substrate or the underlayer in the laminated resin film (hereinafter, “the substrate or the underlayer in the laminated resin film” will be referred to also as “each layer in the laminated resin film”) can be generally obtained by mixing the thermoplastic resin and other components contained in the layer, followed by forming. The forming method is not specifically limited, and various known forming methods can be used individually or in combination for production.

Each layer in the laminated resin film can be formed into a film, for example, by cast molding of extruding a molten resin into a sheet using a single-layer or multilayer T die, I die, or the like connected to a screw extruder, calender molding, roll forming, inflation molding, or the like. Each layer in the laminated resin film may be formed by cast molding or calender molding a mixture of the thermoplastic resin and an organic solvent or oil, followed by removal of the solvent or oil.

A laminate to serve as the laminated resin film may be formed by separately forming each layer in the laminated resin film and laminating the formed layers. Alternatively, a laminate may be obtained by collectively forming each layer together with other layers. For example, a laminate in which the substrate and the underlayer are collectively laminated together can be obtained also by using a forming method such as co-extrusion.

Further, the substrate may have a single-layer structure or a multilayer structure, as described above. For example, in the case where the substrate has a multilayer structure composed of first surface layer/core layer/second surface layer, the substrate with such a multilayer structure may be obtained by individually forming these layers and then laminating the formed layers, or by collectively forming each layer together with other layers.

Examples of a method for forming the laminated resin film by laminating a plurality of layers together include a multilayer die method using a feed block or a multi-manifold, and an extrusion lamination method using a plurality of dies, and these methods can be combined together.

Each layer in the laminated resin film may be a non-stretched film or a stretched film.

Examples of a stretching method include a longitudinal stretching method using a difference in peripheral speed within a roll group, a transverse stretching method using a tenter oven, a sequential biaxial stretching method combining the aforementioned methods, a rolling method, a simultaneous biaxial stretching method by combining a tenter oven and a pantograph, and a simultaneous biaxial stretching by combining a tenter oven and a linear motor. Further, a simultaneous biaxial stretching (inflation molding) method of extruding a molten resin using a circular die connected to a screw extruder into a tube, followed by air inflation can also be used.

At least one of the substrate and the underlayer in the laminated resin film is preferably stretched, for imparting an appropriate stiffness to the recording paper, to enhance the workability when used as a label.

In the case where the substrate has a multilayer structure, at least one layer thereof is preferably stretched.

In the case of stretching a plurality of layers, the layers may be individually stretched before lamination, or the layers may be collectively stretched after lamination. Further, the stretched layers may be stretched again after lamination.

In the case where the thermoplastic resin used for each layer in the laminated resin film is an amorphous resin, the stretching temperature during stretching is preferably within the range of the glass transition temperature of the thermoplastic resin or higher. Further, in the case where the thermoplastic resin is a crystalline resin, the stretching temperature is preferably a temperature within the range of the glass transition temperature of the amorphous part of the thermoplastic resin or higher and the melting point of the crystalline part of the thermoplastic resin or lower, specifically, lower than the melting point of the thermoplastic resin by 2 to 60° C.

The stretching speed when forming each layer in the laminated resin film is not specifically limited but is preferably within the range of 20 to 350 m/minute for stable stretch forming.

Further, the stretch ratio when forming each layer in the laminated resin film can also be appropriately determined in consideration of characteristics or the like of the thermoplastic resin to be used. For example, in the case of stretching a thermoplastic resin film containing a homopolymer of propylene or a copolymer thereof in one direction, the stretch ratio is generally about 1.2 times or more, preferably 2 times or more, and generally 12 times or less, preferably 10 times or less. Meanwhile, the stretch ratio in the case of biaxial stretching is generally 1.5 times or more, preferably 10 times or more, and generally 60 times or less, preferably 50 times or less, in terms of area stretch ratio.

Further, in the case of stretching a thermoplastic resin film containing a polyester resin in one direction, the stretch ratio is generally 1.2 times or more, preferably 2 times or more, and generally 10 times or less, preferably 5 times or less. In the case of biaxial stretching, the stretch ratio is generally 1.5 times or more, preferably 4 times or more, and generally 20 times or less, preferably 12 times or less, in terms of the area stretch ratio.

For example, in the case where the substrate contains a filler, when the stretch ratio in stretching the substrate is within the aforementioned range, a desired porosity is obtained, and the opacity is easily improved. Further, there is a tendency that the substrate is less likely to break, and stable stretch forming can be achieved.

### <<Surface Treatment>>

In the laminated resin film, the underlayer is preferably subjected to surface treatment so as to activate the surface for enhancing the adhesion to the resin coating.

Examples of the surface treatment include corona discharge treatment, frame treatment, plasma treatment, glow discharge treatment, and ozone treatment, and these treatments can be combined. Among these, corona discharge treatment or frame treatment is preferable, and corona treatment is more preferable.

The amount of discharge when performing the corona discharge treatment is preferably 600 J/m² (10 W·minute/m²) or more, more preferably 1,200 J/m² (20 W·minute/m²) or more. Further, the amount of discharge is preferably 12,000 J/m² (200 W·minute/m²) or less, more preferably 10,800 J/m² (180 W·minute/m²) or less. The amount of discharge when performing the frame treatment is preferably 8,000 J/m² or more, more preferably 20,000 J/m² or more. Further, the amount of discharge is preferably 200,000 J/m² or less, more preferably 100,000 J/m² or less.

In particular, the elemental composition ratio (O/C) of oxygen to carbon on the surface of the underlayer after surface treatment is preferably 0.01 to 0.5. When the elemental composition ratio (O/C) falls within the range, the adhesion to the resin coating is further improved.

The elemental composition ratio (O/C) is an abundance ratio (O/C) of oxygen to carbon determined from a ratio of values obtained by multiplying the peak intensity areas of O1s and C1s, as determined by XPS measurement of a surface after surface treatment (X-ray photoelectron spectroscopy), by the relative sensitivity of each peak (for example, see “Basis and applications of polymer surface (vol. 1)”, edited by Yoshito Ikada and published by Kagaku-Doujin, 1986, Chapter 4). The elemental composition ratio (O/C) can be adjusted within the range by adjusting the surface treatment condition. For example, when the surface treatment condition is set to 60 W·minute/m² (3,600 J/m²) to 400 W·minute/m² (24,000 J/m²), the elemental composition ratio (O/C) can be adjusted to the aforementioned range.

### <Resin Coating>

The resin coating contains a resin that is a reaction product of a cationic water-soluble polymer and a silane coupling agent, and an inorganic filler, as required, and is free from thermoplastic resin particles. The resin coating in the present invention is generally a film on which characters, images, and the like can be recorded by printing, writing tools, and the like.

### <<Method for Producing Resin Coating>>

The resin coating in the present invention can be formed by applying an aqueous solution that contains a cationic water-soluble polymer and a silane coupling agent on the surface of the laminated resin film on which the underlayer is disposed, and an inorganic filler, as required, and is free from thermoplastic resin particles (which may be hereinafter referred to as “coating solution for forming a resin coating”), followed by drying. Here, the reaction rate between the cationic water-soluble polymer and the silane coupling agent is not necessarily 100%. That is, the resin coating may contain an unreacted cationic water-soluble polymer and an unreacted silane coupling agent other than the resin that is the reaction product (product produced by the reaction). Further, the coating solution for forming a resin coating can be obtained by mixing the cationic water-soluble polymer, the silane coupling agent, and an aqueous solvent, followed by stirring. The coating solution for forming a resin coating may be obtained by mixing an aqueous solution of the cationic water-soluble polymer and an aqueous solution of the silane coupling agent.

The cationic water-soluble polymer (unreacted component), the silane coupling agent (unreacted component), and the reaction product of the cationic water-soluble polymer and the silane coupling agent in the resin coating can be investigated by time-of-flight secondary ion mass spectrometry (TOF-SIMS).

The resin coating containing the resin that is the reaction product is free from emulsion-derived olefin copolymer particles and therefore has fewer asperities on the surface, as compared with a resin coating formed by applying a coating solution containing an olefin copolymer emulsion. Therefore, the recording paper having excellent appearance with high gloss and high transparency can be obtained. Since separation of the resin coating is less likely to occur, fluffing is also less likely to occur. Further, the resin coating can achieve sufficient adhesion to thermoplastic resins composed of homopolymers such as homopolypropylene, which generally have low adhesion to other resins, and therefore can enhance the adhesion to an object on which the resin film is provided, regardless of the type of thermoplastic resin used for the object. That is, since the resin coating has high adhesion to the substrate, the coating may be directly provided on the substrate, but the underlayer interposed therebetween further improves the adhesion to the substrate. Therefore, the resin coating is provided on the underlayer in the recording paper of the present invention. Further, the resin coating is suitable not only for ink used for common printing systems such as offset printing system using oily ink or UV ink and UV flexographic printing system but also for UV ink-jet printing system and dry electrophotographic printing system. Further, also in the cases of using a liquid toner for wet electrophotographic printing system, sufficiently high adhesion, particularly, water resistant adhesion can be obtained. Accordingly, recording paper with printability in various printing systems including the wet electrophotographic printing system can be provided, and printings with high water resistance and less ink or toner dropping can be provided by using such recording paper.

### <<Cationic Water-Soluble Polymer>>

In the resin coating, the cationic water-soluble polymer is contained as a resin that is a reaction product with a silane coupling agent. However, as described above, the resin coating may contain an unreacted cationic water-soluble polymer.

It is inferred that the resin coating is capable of chemical adhesion (specifically, adhesion by ion binding) and dispersion adhesion (specifically, adhesion by van der Waals force) to ink or toner due to the polar groups of the cationic water-soluble polymer, thereby improving the transferability and the adhesion of ink or toner to the resin coating.

The cationic water-soluble polymer may have a water solubility to an extent such that an aqueous medium containing the cationic water-soluble polymer is in the form of a solution when preparing the coating solution for forming a resin coating described above.

Examples of the cationic water-soluble polymer that can be used include (meth)acrylic polymers or ethyleneimine polymers having an amino group or an ammonium salt structure, water-soluble polymers having a phosphonium salt structure, and vinyl polymers obtained by cationizing water-soluble polymers such as polyvinylpyrrolidone and polyvinyl alcohol by modification. One of these can be used singly or two or more of these can be used in combination. Among these, (meth)acrylic polymers or ethyleneimine polymers having an amino group or an ammonium salt structure are preferable in view of the transferability and the adhesion of ink or toner to the resin coating.

The (meth)acrylic polymers or the ethyleneimine polymers having an amino group or an ammonium salt structure preferably has a primary to tertiary amino group or a primary to tertiary ammonium salt structure, more preferably a secondary to tertiary amino group or a secondary to tertiary ammonium salt structure, further preferably a tertiary amino group or a tertiary ammonium salt structure, in view of the safety. Further, for obtaining a resin with high degree of crosslinking by the reaction with the silane coupling agent and achieving high adhesion of ink or toner to the resin coating, a primary to tertiary amino group or a primary to tertiary ammonium salt structure is preferable, a primary to secondary amino group or a primary to secondary ammonium salt structure is more preferable, and a primary amino group or a primary ammonium salt structure is further preferable.

Among these, ethyleneimine polymers are preferable because of their high affinity to ink or toner used in various printing systems, particularly, ultraviolet curable ink used in the flexographic printing system, thereby improving the adhesion between the resin coating and ink.

Examples of the ethyleneimine polymers include polyethyleneimine, poly(ethyleneimine-urea), an ethyleneimine adduct of polyamine polyamide, alkyl-modified products, cycloalkyl-modified products, aryl-modified products, allyl-modified products, aralkyl-modified products, benzyl-modified products, cyclopentyl-modified products, cyclic aliphatic hydrocarbon-modified products, and glycidol-modified products of these, and hydroxides of these. Examples of modifiers for obtaining such modified products include methyl chloride, methyl bromide, n-butyl chloride, lauryl chloride, stearyl iodide, oleyl chloride, cyclohexyl chloride, benzyl chloride, allyl chloride, and cyclopentyl chloride.

Among these, ethyleneimine polymers represented by Formula (I) below are preferable for improving the transferability and the adhesion of ink or toner, particularly, ultraviolet curable ink used for printing.

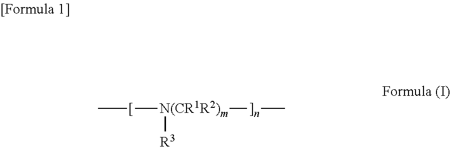

wherein R¹ and R² each independently represent a hydrogen atom; a linear or branched alkyl group having 1 to 12 carbon atoms; or an alkyl group or an aryl group having an alicyclic structure and 6 to 12 carbon atoms; R³ represents a hydrogen atom; an alkyl group or an allyl group having 1 to 18 carbon atoms and optionally having a hydroxy group; or an alkyl group or an aryl group having 6 to 12 carbon atoms and an alicyclic structure and optionally having a hydroxy group; m represents an integer of 2 to 6; and n represents an integer of 20 to 3000.

As the (meth)acrylic polymers or ethyleneimine polymers having an amino group or an ammonium salt structure, commercially available products can also be used.

Examples of the commercially available products of the (meth)acrylic polymers having an amino group or an ammonium salt structure include POLYMENT (available from NIPPON SHOKUBAI CO., LTD).

Further, examples of the commercially available products of the ethyleneimine polymers include EPOMIN (available from NIPPON SHOKUBAI CO., LTD.) and Polymin SK (available from BASF SE).

The weight-average molecular weight of the (meth)acrylic polymers or the ethyleneimine polymers having an amino group or an ammonium salt structure is preferably 10,000 or more, more preferably 20,000 or more, for improving the adhesion to the substrate and the adhesion to ink or the like. Meanwhile, the weight-average molecular weight thereof is preferably 1,000,000 or less, more preferably 500,000 or less.

In the present invention, the weight-average molecular weight and the number-average molecular weight of the resin can be determined by calculating the values measured by GPC (Gel Permeation Chromatography) in terms of polystyrene.

The coating solution for forming a resin coating may contain polymers other than the cationic water-soluble polymer within a range that does not considerably impair the expression of the excellent effects of the resin coating.

### <<Silane Coupling Agent>>

In the resin coating, the silane coupling agent is contained as a resin that is a reaction product with the cationic water-soluble polymer. However, as described above, the resin coating may contain an unreacted silane coupling agent.

It is inferred that the silane coupling agent contributes to the expression of the function to enhance the adhesion between the laminated resin film and the resin coating.

Specifically, it is inferred that, since the silane coupling agent has a functional group having high reactivity with organic materials, the functional group enhances the adhesion to the laminated resin film through crosslinking reaction between the thermoplastic resin of the underlayer and the cationic water-soluble polymer and prevents penetration of moisture between the laminated resin film and the resin coating. It is inferred that this enhances the scratch resistance by suppressing peeling of the resin coating and separation of ink or toner from printings. Further, it is inferred that the silane coupling agent causes crosslinking reaction within the cationic water-soluble polymer to form a mesh structure, and the mesh structure enhances the transferability and the adhesion of ink or toner. Further, it is inferred that the silane coupling agent improves the water resistance by crosslinking with the cationic water-soluble polymer and further increasing the molecular weight of hydrophilic components (polar resin components) of the cationic water-soluble polymer.

As the silane coupling agent, a silane coupling agent having a group that reacts with the cationic water-soluble polymer, for example, various functional groups such as a silanol group can be used. The group that reacts with the cationic water-soluble polymer refers to a group that forms a bond by reacting with an atom or an atomic group contained in the cationic water-soluble polymer. The bond formed by the reaction may be any of a covalent bond, an ionic bond, a hydrogen bond, and the like and is not particularly limited.

Specifically, a silane coupling agent having an alkoxysilyl group or a silanol group formed by hydrolysis of the alkoxysilyl group together with at least one functional group other than the silanol group such as an epoxy group, a vinyl group, a (meth)acrylic group, an amino group, an ureide group, a mercapto group, an isocyanate group in the molecule can be used.

It is inferred that, in the silane coupling agent, the functional group other than the silanol group undergoes a condensation reaction with a (meth)acrylic acid residue in the (meth)acrylic polymers having an amino group or an ammonium salt structure contained in the resin coating, or the amino group or the like in the ethyleneimine polymers, while the silanol group undergoes a condensation reaction with the thermoplastic resin of the underlayer, thereby causing the crosslinking reaction.

Alternatively, it is inferred that, in the silane coupling agent, the functional group other than the silanol group binds to the thermoplastic resin of the underlayer with high affinity, while the silanol group undergoes a condensation reaction with a (meth)acrylic acid residue in the (meth)acrylic polymers having an amino group or an ammonium salt structure, or the amino group in the ethyleneimine polymers, thereby causing the crosslinking reaction.

The content of the alkoxysilyl group or the silanol group formed by hydrolysis of the alkoxysilyl group in the silane coupling agent is preferably 25% or more, more preferably 50% or more, and preferably 75% or less, for allowing firm adhesion between the laminated resin film and the resin coating and firm adhesion between the resin coating and ink or toner. Meanwhile, the content of the reactive functional group other than the alkoxysilyl group or the silanol group formed by hydrolysis of the alkoxysilyl group in the silane coupling agent is preferably 25% or more, and preferably 75% or less, more preferably 50% or less.

Specific examples of the silane coupling agent that can be used include epoxy silane coupling agents, vinyl silane coupling agents, (meth)acrylic silane coupling agents, amino silane coupling agents, ureide silane coupling agents, mercapto silane coupling agents, and isocyanate silane coupling agents.

Examples of the epoxy silane coupling agents include 3-glycidoxypropyltrimethoxysilane, 3-glycidoxypropylmethyldimethoxysilane, 3-glycidoxypropylmethyldiethoxysilane, 3-glycidoxypropyltriethoxysilane, and 2-(3,4-epoxycyclohexyl)ethyltrimethoxysilane. Among these, 3-glycidoxypropyltrimethoxysilane is preferable in view of the adhesion to ink or toner.

Examples of the vinyl silane coupling agents include vinyltrimethoxysilane and vinyltriethoxysilane.

Examples of the (meth)acrylic silane coupling agents include 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

Examples of the amino silane coupling agents include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and N-(vinylbenzyl)-2-aminoethyl-3-aminopropyltrimethoxysilane.

Examples of the ureide silane coupling agents include 3-ureidopropyltriethoxysilane.

Examples of the mercapto silane coupling agents include 3-mercaptopropylmethyldimethoxysilane and 3-mercaptopropyltrimethoxysilane.

Examples of the isocyanate silane coupling agents include 3-isocyanate propyltriethoxysilane.

One of these silane coupling agents can be used singly, or two or more of these can be used in combination.

As commercially available products of the silane coupling agent, KBM-303, KBM-402, KBM-403, KBE-402, KBE-403, KBM-1003, KBE-1003, KBM-502, KBM-503, KBE-502, KBE-503, KBM-5103, KBM-602, KBM-603, KBM-903, KBE-903, KBE-9103, KBM-573, KBM-575, KBE-585, KBM-802, KBM-803, and KBE-9007 (all are product names), available from Shin-Etsu Chemical Co., Ltd.; Z-6043, Z-6040, Z-6519, Z-6300, Z-6030, Z-6011, Z-6094, and Z-6062 (all are product names) available from Dow Corning Toray Co., Ltd., and the like can be used.

Among these, the epoxy silane coupling agents, the amino silane coupling agents, the mercapto silane coupling agents, or the isocyanate silane coupling agents are preferable, the epoxy silane coupling agents or the amino silane coupling agents are more preferable, and the epoxy silane coupling agents are further preferable, in view of the adhesion to ink or toner.

The epoxy silane coupling agents, the ureide silane coupling agents, or the isocyanate silane coupling agents are preferable, and the epoxy silane coupling agents are more preferable, for ease of the crosslinking reaction with the primary to tertiary amino group contained in the cationic water-soluble polymer.

In the case of using a polyolefin resin as the thermoplastic resin of the underlayer, the vinyl silane coupling agents or the (meth)acrylic silane coupling agents are preferable in view of the adaptability to the laminated resin film.

Further, in the case where metal oxide particles such as inorganic fillers are present on the surface of the substrate, the amino silane coupling agents, the ureide silane coupling agents, or the mercapto silane coupling agents are preferably used, for enhancing the adhesion to the substrate by strongly binding to the particles.

It is known that the hydrolysis rate of the silane coupling agent can be controlled depending on the type of alkoxysilyl group. Using such a property, deterioration of the coating solution for forming a resin coating due to self-condensation of the silane coupling agent can be suppressed, and the time transient stability can be enhanced. For achieving high solubility in water, ease of preparation of the coating solution for forming a resin coating, and high time transient stability, the epoxy silane coupling agents are preferable as the silane coupling agent. Among these, 3-glycidoxypropyltrimethoxysilane is preferable.

In the coating solution for forming a resin coating, the alkoxysilane group in the molecule of the silane coupling agent transforms into the silanol group by hydrolysis, and it is inferred that the silanol group undergoes chemical bonding such as hydrogen bonding with the functional group such as a hydroxy group and a carboxy group on the surface-treated underlayer, thereby improving the adhesion between the substrate or the laminated resin film and the resin coating. Further, it is inferred that the condensation reaction within the silanol group improves the cohesion of the resin coating itself, thereby improving the physical strength of the resin coating itself.

For achieving excellent adhesion of the resin coating to ink or toner, the amount of the unreacted silane coupling agent to be contained in the coating solution for forming a resin coating is preferably not too large. When an excessive amount of the unreacted silane coupling agent is contained, the resin coating to be obtained may become hard and may not be able to follow the bending of the recording paper and thus crack, or the ink or toner may peel off. Further, for achieving excellent water resistance of the resin coating, the amount of the unreacted cationic water-soluble polymer is preferably small. From these viewpoints, the amount of the silane coupling agent in the coating solution for forming a resin coating is 15 parts by mass or more, preferably 17 parts by mass or more, and 60 parts by mass or less, preferably 55 parts by mass or less, more preferably 50 parts by mass or less, further preferably 35 parts by mass or less, particularly preferably 30 parts by mass or less, most preferably 25 parts by mass or less, with respect to 100 parts by mass of the cationic water-soluble polymer. That is, the content of the silane coupling agent component (total amount of unreacted and reacted parts: the same applies below) in the resin coating is 15 parts by mass or more, preferably 17 parts by mass or more, and 60 parts by mass or less, preferably 55 parts by mass or less, more preferably 50 parts by mass or less, further preferably 35 parts by mass or less, particularly preferably 30 parts by mass or less, most preferably 25 parts by mass or less, with respect to 100 parts by mass of the cationic water-soluble polymer component (total amount of unreacted and reacted parts: the same applies below) in the resin coating.

Within such a range, the recording paper of the present invention, for example, when used in the wet electrophotographic printing system using liquid toner has sufficient adhesion to the toner, and printings with high water resistance and less toner dropping can be achieved.

### <<Inorganic Filler>>

The content of inorganic filler in the coating solution for forming a resin coating is 9 parts by mass or less with respect to 100 parts by mass of the cationic water-soluble polymer. That is, the inorganic filler is not contained, or if it is contained, the content thereof is 9 parts by mass or less. When the content of the inorganic filler is 9 parts by mass or less with respect to 100 parts by mass of the cationic water-soluble polymer, it is possible to effectively prevent white spots in the printed portion due to the asperities of the resin coating caused by the inorganic filler and to achieve high ink transfer rate. Further, it is possible to effectively prevent the recording paper from becoming dirty due to the inorganic filler falling out and to reflect the texture (paper quality) of the laminated resin film better. From such viewpoints, the content of the inorganic filler is preferably 5 parts by mass or less, more preferably 3 parts by mass or less, further preferably 0.1 parts by mass or less, and it is particularly preferable that the inorganic filler is not contained.

That is, the content of the inorganic filler in the resin coating in the present invention is 9 parts by mass or less, preferably 5 parts by mass or less, more preferably 3 parts by mass or less, further preferably 0.1 parts by mass or less, particularly preferably 0 parts by mass (not contained), with respect to 100 parts by mass of the cationic water-soluble polymer component.

Meanwhile, for preventing blocking, a small amount of inorganic filler is preferably contained in the resin coating. Specifically, the content of the inorganic filler in the coating solution for forming a resin coating is preferably 0.1 parts by mass or more, more preferably 0.2 parts by mass or more, further preferably 0.3 parts by mass or more, with respect to 100 parts by mass of the cationic water-soluble polymer. That is, the content of the inorganic filler in the resin coating in the present invention is preferably 0.1 parts by mass or more, more preferably 0.2 parts by mass or more, further preferably 0.3 parts by mass or more, with respect to 100 parts by mass of the cationic water-soluble polymer component.

The coating solution for forming a resin coating can contain other aid components such as antistatic agents, crosslinking accelerators, anti-blocking agents, pH adjusters, and defoamers, as required. That is, the resin coating may contain other aid components such as antistatic agents, crosslinking accelerators, anti-blocking agents, pH adjusters, and defoamers, as required.

### <<Antistatic Agent>>

The resin coating in the present invention preferably contains an antistatic agent, for preventing dust deposition due to electrification and conveyance failure during printing and improving the handling properties of the recording paper.

Among antistatic agents, polymeric antistatic agents are preferable for reducing surface contamination due to bleeding out.

The polymeric antistatic agents are not specifically limited, and cationic, anionic, amphoteric, or nonionic antistatic agents can be used. One of these can be used singly, or two or more of these can be used in combination.

Examples of the cationic antistatic agents can include an antistatic agent having an ammonium salt structure, a phosphonium salt structure, or the like. Examples of the anionic antistatic agents can include an antistatic agent having a structure of sulfonate, phosphate, carboxylate, or the like of alkali metal salts (such as lithium salt, sodium salt, and potassium salt). Examples of the anionic antistatic agents may include an antistatic agent having a structure of acrylate, methacrylate, (anhydrous) maleate, or the like of alkali metal salts in the molecular structure.

Examples of the amphoteric antistatic agents can include an antistatic agent having the structures of both a cationic antistatic agent and an anionic antistatic agent in the same molecule. Examples of the amphoteric antistatic agents include betaine-type antistatic agents. Examples of the nonionic antistatic agents can include an ethylene oxide polymer having an alkylene oxide structure and a polymer having an ethylene oxide polymer component in the molecular chain. Examples of other antistatic agents include a polymeric antistatic agent having boron in the molecular structure.

Among these, cationic antistatic agents are preferable, nitrogen-containing polymeric antistatic agents are more preferable, an antistatic agent having an ammonium salt structure is further preferable, an acrylic resin having a tertiary or quaternary ammonium salt structure is particularly preferable, and an acrylic resin having a quaternary ammonium salt structure is most preferable, as the polymeric antistatic agents.

As the polymeric antistatic agents, commercially available products such as SAFTOMER ST-1000, ST-1100, and ST-3200 (product names) available from Mitsubishi Chemical Corporation can be used.

As the polymeric antistatic agents, compounds that react with the silane coupling agent may be used, and compounds that do not react therewith may be used. However, in view of ease of expression of the antistatic performance, compounds that do not react with the silane coupling agent are preferable.

The amount of the antistatic agent contained in the coating solution for forming a resin coating is preferably 0.01 parts by mass or more, more preferably 1 part by mass or more, further preferably 2 parts by mass or more, with respect to 100 parts by mass of the cationic water-soluble polymer, for preventing electrification. Further, the amount of the antistatic agent contained in the coating solution for forming a resin coating is preferably 45 parts by mass or less, more preferably 40 parts by mass or less, further preferably 35 parts by mass or less, with respect to 100 parts by mass of the cationic water-soluble polymer, in view of the water resistance of the resin coating.

### <<Crosslinking Accelerator>>

Examples of the crosslinking accelerators include phosphoric acid, sulfuric acid, citric acid, and succinic acid.

The thickness of the resin coating is preferably 0.01 to 5 μm. For stably forming a uniform resin coating, the thickness of the resin coating is preferably 0.01 μm or more, more preferably 0.02 μm or more, further preferably 0.03 μm or more. Meanwhile, for effectively suppressing bleeding out of additives or low-molecular weight compounds contained in the laminated resin film to achieve good ink transferability even after storage in a high-temperature and high-humidity environment, the resin coating is preferably comparatively thick. Specifically, the thickness is preferably 0.1 μm or more, more preferably 0.25 μm or more, further preferably 0.3 μm or more.

Meanwhile, for effectively preventing the reduction in adhesion to the laminated resin film due to cohesive failure of the resin coating, the thickness of the resin coating is preferably 5 μm or less, more preferably 3 μm or less, further preferably 1.5 μm or less. Further, in order to reflect the texture (paper quality) of the laminated resin film better, the resin coating is preferably comparatively thin. Specifically, the thickness is preferably 1.0 μm or less, more preferably 0.8 μm or less, further preferably 0.5 μm or less.

### <<Thermoplastic Resin Particles>>

As described above, the resin coating is free from thermoplastic resin particles. The thermoplastic resin particles mean particles dispersed in a dispersion medium within the coating solution for forming a resin coating and derived from an emulsion of a thermoplastic resin such as an olefin copolymer.

It is possible to avoid blocking due to thermal fusion of the thermoplastic resin and changes in gloss on the surface of the resin coating before and after printing or forming by being free from thermoplastic resin particles. Further, it is possible to obtain recording paper with excellent appearance such as glossiness and transparency since the uniformity of the surface of the resin coating is enhanced. Further, the adhesion to toner, particularly, the liquid toner used in wet electrophotographic printing system is improved, and the adhesion to the laminated resin film is improved even in the case where the thermoplastic resin that is used for the underlayer of the laminated resin film contains homopolypropylene.

The configuration of the resin coating that is free from thermoplastic resin particles and the uniformity on the surface of the resin coating can be investigated by observation using a scanning electron microscope or the like.

As disclosed in International Publication No. 2014/092142, the olefin copolymer emulsion is an emulsion obtained by dispersing or emulsifying an olefin copolymer in an aqueous dispersion medium into particulate form. In the emulsion, a nonionic or cationic surfactant, a nonionic or cationic water-soluble polymer, or the like may be used as a dispersant.

Examples of the olefin copolymer dispersed or emulsified in the emulsion include an olefin copolymer having good emulsifiability and containing a constituent unit having a carboxy group or a salt thereof as a copolymer component. Representative examples of such a copolymer can include a copolymer of an olefin monomer with an unsaturated carboxylic acid or an anhydride thereof, and a salt thereof. Specific examples include an ethylene-(meth)acrylic acid copolymer, an ethylene-(meth)acrylate copolymer, an alkali (earth) metal salt of an ethylene-(meth)acrylic acid copolymer, an ethylene-(meth)acrylate-maleic anhydride copolymer, a (meth)acrylic acid-grafted polyethylene, an ethylene-vinyl acetate copolymer, a maleic anhydride-grafted polyethylene, a maleic anhydride-grafted ethylene-vinyl acetate copolymer, a maleic anhydride-grafted (meth)acrylate-ethylene copolymer, a maleic anhydride-grafted polypropylene, a maleic anhydride-grafted ethylene-propylene copolymer, a maleic anhydride-grafted ethylene-propylene-butene copolymer, a maleic anhydride-grafted ethylene-butene copolymer, and a maleic anhydride-grafted propylene-butene copolymer.

The olefin copolymer particles in the emulsion are generally particles with a volume-average particle size of about 0.2 to 3 μm. The volume-average particle size is a volume-average particle size measured using a laser diffraction particle size distribution analyzer (available from SHIMADZU CORPORATION: SALD-2200).

As disclosed in International Publication No. 2014/092142, the adhesion to toner, particularly, liquid toner in the wet electrophotographic printing system becomes more insufficient when the resin coating contains thermoplastic resin particles other than olefin copolymer particles such as acrylic copolymer particles or urethane copolymer particles, than in the case of containing olefin copolymer particles.

The resin coating is disposed facing the underlayer of the laminated resin film, but the resin coating may be formed not only on one side of the laminated resin film but also on each of both sides of the laminated resin film. For example, in the case where the underlayer is disposed on each of both sides of the substrate, the resin coating may be formed on each underlayer. Alternatively, in addition to the underlayer disposed on one side of the substrate and the resin coating formed on the underlayer, a resin coating may be further formed on the other side of the substrate.

### <Method for Using Recording Paper>

As described above, the resin coating in the recording paper of the present invention is a recordable film. Examples of the way of recording include recording by printing, writing tools, and the like.

Since the recording paper of the present invention can be used in various printing methods including offset printing, letter press printing, gravure printing, flexographic printing, and screen printing and is excellent not only in adhesion to ink of printings obtained but also in water resistance, weather resistance, and durability, the recording paper is suitably used as printing paper for posters used indoor and outdoor, stickers used indoor and outdoor, container labels for frozen foods, namers (labels showing usage and notes) of industrial products, and the like.

The recording paper of the present invention is also excellent in adhesion to toner for printings to be obtained, particularly, in the wet electrophotographic printing system using liquid toner and is suitable also for applications of small-lot printing and variable information printing. Further, since the recording paper of the present invention is excellent in water resistance of not only printings themselves but also printings laminated, the recording paper is suitably used as printing paper for menus, photo books, posters, stickers, and the like used indoor and outdoor.

When printing is performed on the recording paper, a printed layer such as ink is formed on the surface of the resin coating of the recording paper. For example, as shown in the schematic view of FIG. 1, a printed layer 5 is formed on the surface of the resin coating 3 of the recording paper.

For protecting the printed surface, a protective layer may be further provided on the printed layer.

The protective layer is located on the outermost surface on the resin coating 3 side on which the printed layer is provided. The protective layer can reduce the coefficient of friction on the outermost surface by containing silicone to reduce damage, dirt, and the like of the printed layer. Silicone is a silicon compound having a polysiloxane bond.

### <Characteristics of Recording Paper>

As described above, the recording paper of the present invention can have the structure exemplified in FIG. 1. The resin coating 3 is not only a good printing reception layer but also excellent in adhesion to the substrate. Further, it is inferred that the adhesion between the substrate 1 and the resin coating 3 is further improved by providing the underlayer 2 between the substrate 1 and the resin coating 3.

It is further inferred that the recording paper of the present invention serves as a recording paper with high adhesion, particularly, high water resistant adhesion, without ink transfer failure, reduction in ink adhesion of printings, blocking, and change in paper quality after printing, as shown in Examples below.

### (Adhesive Label)

Then, the adhesive label of the present invention will be described in detail, but the configuration requirement described below is an example as one embodiment of the present invention (representative example) and is not specified by these contents.

The adhesive label of the present invention includes a laminated resin film, a resin coating disposed on each of both sides of the laminated resin film, and an adhesive layer.

The laminated resin film has a substrate composed of a thermoplastic resin film, a first underlayer composed of a thermoplastic resin composition and disposed on one side of the substrate, and a second underlayer composed of a thermoplastic resin composition and disposed on the other side of the substrate.

FIG. 2 shows a configuration example of the adhesive label as one embodiment of the present invention.

As shown in FIG. 2, an adhesive label 40 includes the laminated resin film 101 having the substrate 1, a first underlayer 21 composed of a thermoplastic resin composition located on one side of the substrate 1, and a second underlayer 22 composed of a thermoplastic resin composition located on the other side of the substrate 1.

Further, the adhesive label 40 includes a resin coating 31 disposed facing the first underlayer 21 of the laminated resin film, a resin coating 32 disposed facing the second underlayer 22 of the laminated resin film, and an adhesive layer 4 disposed on the resin coating 32 facing the second underlayer 22 on the opposite side of the second underlayer 22.

In this description, the laminated resin film and the resin coating disposed on each of both sides of the laminated resin film may be collectively referred to as a recording paper. Specifically, a laminate composed of the resin coating 31, the laminated resin film 101 (including the first underlayer 21, the substrate 1, and the second underlayer 22), and the resin coating 32 in FIG. 2 may be referred to as a recording paper 102.

The adhesive label 40 is a laminate of the recording paper 102 and the adhesive layer 4.

### <Laminated Resin Film>

The laminated resin film in the adhesive label of the present invention has a substrate composed of a thermoplastic resin film, a first underlayer composed of a thermoplastic resin composition and disposed on one side of the substrate, and a second underlayer composed of a thermoplastic resin composition and disposed on the other side of the substrate.

### <<Substrate>>

In the adhesive label of the present invention, the substrate is composed of a thermoplastic resin film.

Examples of the thermoplastic resin, the filler, and other components to be contained in the thermoplastic resin film are all the same as described in (Recording paper), and preferable materials and preferable contents are also the same. The porosity of the substrate is also as described in (Recording paper).

The layer structure and the thickness of the substrate are also as described in (Recording paper). The thickness of the substrate is preferably 30 μm or more, more preferably 50 μm or more, for ease of achieving sufficient mechanical strength for use as an adhesive label. For reducing the weight of the label itself to enhance the handleability, the thickness is preferably 200 μm or less, more preferably 150 μm or less.

### <<First Underlayer and Second Underlayer>>

In the adhesive label of the present invention, the substrate has the first underlayer and the second underlayer on both sides thereof. Both are the same as described in <<Underlayer>> of (Recording paper), and preferable embodiments are also the same. The thickness of each of the first underlayer and the second underlayer is preferably 1 μm or more, more preferably 2 μm or more, for enhancing the adhesion between the substrate and the resin coating. Further, since the thickness of the adhesive label is preferably 200 μm or less for reducing the weight of the label itself to enhance the handleability, the thickness of the underlayer is preferably 50 μm or less, more preferably 30 μm or less, in order to adjust the thickness of the adhesive label to such a range. The types, the contents, the thicknesses, and the indentation moduli of the components constituting the first underlayer and the second underlayer may be the same or different.

Further, the surfaces of the first underlayer and the second underlayer, that is, the surfaces on each of which the resin coating is provided, which will be described below, may be subjected to surface treatment, as described in (Recording paper).

### <<Method for Producing Laminated Resin Film>>

In the adhesive label of the present invention, the substrate, the first underlayer, or the second underlayer of the laminated resin film can be generally obtained by mixing the aforementioned thermoplastic resins and other components contained in the layers, followed by forming. Examples of the forming method are the same as described in (Recording paper). The stretching temperature, the stretching speed, the stretch ratio, and the like are also as described in (Recording paper).

For imparting an appropriate stiffness to the adhesive label, to enhance the workability when used as a label, at least one of the substrate, the first underlayer, and the second underlayer in the laminated resin film is preferably stretched.

Further, in the case where the substrate has a multilayer structure, at least one layer thereof is preferably stretched.

In the case of stretching a plurality of layers, the layers may be individually stretched before lamination, or the layers may be collectively stretched after lamination. Further, the stretched layers may be stretched again after lamination.

### <<Resin Coating>>

In the adhesive label of the present invention, the resin coating disposed on each of both sides of the laminated resin film contains a resin that is a reaction product of a cationic water-soluble polymer and a silane coupling agent and is free from thermoplastic resin particles. The resin coating in the present invention is a film on which characters, images, and the like can be recorded by printing, writing tools, and the like. Further, the resin coating is a layer with good adhesiveness to the adhesive layer, which will be described below. Lamination via the resin coating improves the adhesiveness between the laminated resin film and the adhesive layer, and thus the adhesive label of the present invention has an advantage that the adhesive residue is less likely to remain even if the label is attached to another article and then peeled off.

As shown in FIG. 2, the adhesive label of the present invention has two resin coatings (the resin coating 31 and the resin coating 32). The types of the components constituting the resin coatings and the ratios of the structural components may be the same or different.

The resin coating in the present invention can be formed using an aqueous solution containing a cationic water-soluble polymer and a silane coupling agent and free from thermoplastic resin particles. Specifically, the resin coating can be formed by the same method as the method for producing a resin coating described in (Recording paper). Further, examples of the cationic water-soluble polymer, the silane coupling agent, the inorganic filler, and other components (such as antistatic agents, crosslinking accelerators, and anti-blocking agents) are all the same as described in (Recording paper), and preferable materials and preferable contents are also the same.

The thickness of the resin coating is also as described in (Recording paper), and preferable embodiments are also the same.

### <Adhesive Layer>

Examples of the pressure-sensitive adhesive to be used for the adhesive layer include pressure-sensitive adhesives such as rubber-type pressure-sensitive adhesives, acrylic pressure-sensitive adhesives, and silicone-type pressure-sensitive adhesives.

Examples of the rubber-type pressure-sensitive adhesives can include polyisobutylene rubber, butyl rubber, and a mixture thereof, or tackifiers such as abietic acid rosin ester, terpene-phenol copolymer, and terpene-indene copolymer mixed with these rubber-type pressure-sensitive adhesives.

Examples of the acrylic pressure-sensitive adhesives include those having a glass transition temperature of −20° C. or less, such as 2-ethylhexyl acrylate-n-butyl acrylate copolymer and 2-ethylhexyl acrylate-ethyl acrylate-methyl methacrylate copolymer.

Examples of the silicone-type pressure-sensitive adhesives include addition curing pressure-sensitive adhesives catalyzed by platinum compounds, and peroxide curing pressure-sensitive adhesives cured with benzoyl peroxide, or the like.

Examples of the pressure-sensitive adhesives include those of various forms such as solution type, emulsion type, and hot melt type.

The adhesive layer may be formed by directly applying a pressure-sensitive adhesive onto the surface of the recording paper or may be formed by applying a pressure-sensitive adhesive onto the surface of the release sheet, which will be described below, to form an adhesive layer and then applying it onto the surface of the recording paper.

Examples of the coating device for the pressure-sensitive adhesive can include bar coaters, blade coaters, comma coaters, die coaters, air knife coaters, gravure coaters, lip coaters, reverse coaters, roll coaters, and spray coaters. An adhesive layer is formed by smoothing a coating layer such as a pressure-sensitive adhesive applied by these coating devices, as required, and performing a drying step. The coating mass of the pressure-sensitive adhesive is not specifically limited but is preferably 3 g/m² or more, more preferably 10 g/m² or more, and preferably 60 g/m² or less, more preferably 40 g/m² or less, in terms of solid content after drying.

The adhesive layer may be provided with a release sheet on the opposite side to the surface on which the adhesive layer is in contact with the recording paper, as required.

### <<Release Sheet>>

The release sheet is provided on the surface of the adhesive layer that is not in contact with the recording paper, for the purpose of protecting the surface of the adhesive layer, as required. Examples of the release sheet that can be used include high-quality paper or kraft paper, as it is, high-quality paper or kraft paper subjected to calendaring, resin coating, or film lamination, or glassine paper, coating paper, a plastic film, or the like treated with silicone. Among these, those with the surface in contact with the adhesive layer treated with silicone are preferably used, because of good releasability from the adhesive layer.

### <Method for Using Adhesive Label>

As described above, the resin coating is a recordable film. Examples of the way of recording include recording by printing, writing tools, and the like. The adhesive label of the present invention having the adhesive layer via the resin coating can be used as recording paper that can be attached to other articles.

Examples of the printing method are the same as described in (Recording paper). Further, a protective layer may be provided for protecting the printed layer (printed surface), and the material for the protective layer is also the same as described above.

### <Characteristics of Adhesive Label>

As described above, the adhesive label of the present invention has the structure exemplified in FIG. 2. The resin coating 31 is not only a good printing reception layer but also excellent in adhesion to the substrate. Further, it is inferred that the adhesion between the substrate 1 and the resin coating 31 is further improved by providing the first underlayer 21 between the substrate 1 and the resin coating 31.

It is inferred that, although the resin coating 32 contributes to the adhesiveness between the substrate 1 and adhesive layer 4, the adhesion between the substrate 1 and the resin coating 32 is further improved by further providing the second underlayer 22 between the substrate 1 and the resin coating 32.

Further, it is inferred that these are combined together, so that the adhesive label of the present invention has high adhesion, particularly, high water resistant adhesion, less ink transfer failure, less reduction in ink adhesion of printings, no adhesive residue, less blocking, and less change in paper quality after printing, as shown in Examples below.

### (In-Mold Label)

The in-mold label of the present invention has a laminated resin film, a heat sealing layer provided on one side of the laminated resin film, and a resin coating provided on the other side of the laminated resin film. The laminated resin film has a substrate composed of a thermoplastic resin film and an underlayer composed of a thermoplastic resin composition and disposed on one side of the substrate with an indentation modulus within a specific range. The resin coating is provided on the underlayer and is free from thermoplastic resin particles. The in-mold label of the present invention may further have a printed layer to be formed on the resin coating by printing.

The resin coating enhances the adhesion to ink or toner, particularly, water resistant adhesion. Further, since the resin coating has high adhesion to any type of thermoplastic resin, the adhesion to the substrate can be enhanced by the resin coating alone. However, the adhesion between the substrate and the underlayer and the adhesion between the underlayer and the resin coating are further enhanced by providing the underlayer with an indentation modulus within a specific range between the resin coating and the substrate. As a result, the adhesion between the substrate and the resin coating is further enhanced, and therefore the water resistance of the in-mold label as a whole is improved, to achieve excellent printability and excellent suitability for in-mold molding. Since the resin coating is free from thermoplastic resin particles, blocking and change in gloss on the surface of the resin coating due to thermal fusion of thermoplastic resin particles are less.

In the case where a resin container using the in-mold label of the present invention is a polyethylene terephthalate (PET) resin container, the in-mold label of the present invention preferably further has a resin coating also on the heat sealing layer, for improving the adhesion between the PET resin container and the heat sealing layer. The PET resin has low melt viscosity as compared with a polyethylene resin or the like, and thus a stretch blow method in which heating is performed up to about the softening point instead of the melting point is used at the time of forming. A low-melting point resin is used for the heat sealing layer so as to be thermally fused sufficiently under such low-temperature forming conditions. The resin coating has high adhesion to the low-melting point resin and contains a cationic water-soluble polymer having a polar group, as described below, thereby having high adhesion also to the PET resin. That is, since the resin coating further increases the adhesion between the heat sealing layer and the PET resin container to improve the water resistance, it is possible to provide an in-mold label that is less likely to peel off when wet with water and is particularly useful for containers of liquid such as beverages. In the two resin coatings in this case, the types and ratios of the components constituting the resin coatings may be the same or different, as long as the effects of the present invention are obtained.

FIG. 3 shows a configuration example of an in-mold label 50a as one embodiment of the present invention.

As shown in FIG. 3, the in-mold label 50a has the substrate 1, the underlayer 2, a heat sealing layer 6, and the resin coating 3. The underlayer 2 is provided on one side of the substrate 1, and the resin coating 3 is provided on the underlayer 2. The heat sealing layer 6 is provided on the other side of the substrate 1 and located on the opposite side of the underlayer 2 with the substrate 1 interposed therebetween. The in-mold label 50a may have the printed layer 5 on the resin coating 3 by printing.

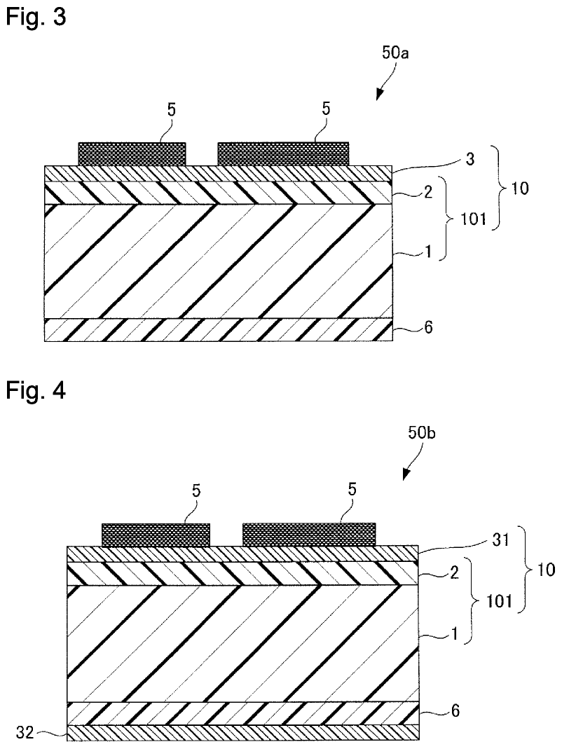

FIG. 4 shows a configuration example of an in-mold label 50b suitable for a PET resin container. In FIG. 4, the same configurations as in the in-mold label 50a of FIG. 3 are denoted by the same reference numerals.

As shown in FIG. 4, the in-mold label 50b has the underlayer 2 on one side of the substrate 1, and the heat sealing layer 6 on the other surface, like the in-mold label 50a. Further, the in-mold label 50b has the resin coating 31 on the underlayer 2 and the resin coating 32 also on the heat sealing layer 6. The printed layer 5 is provided on the resin coating 31 on the underlayer 2 side.

Hereinafter, the laminated resin film and the resin coating on the laminated resin film may be collectively referred to as a recording paper. In the case of the example shown in FIG. 3, the underlayer 2 and the substrate 1 form the laminated resin film 101, and the laminate of the laminated resin film 101 and the resin coating 3 forms the recording paper 10. In the case of the example shown in FIG. 4, the underlayer 2 and the substrate 1 form the laminated resin film 101, and the laminated resin film 101 and the resin coating 31 form the recording paper 10.

### <Laminated Resin Film>

In the in-mold label of the present invention, the laminated resin film has a substrate composed of a thermoplastic resin film and an underlayer composed of a thermoplastic resin composition.

### <<Substrate>>

In the in-mold label of the present invention, the substrate is composed of a thermoplastic resin film. The substrate can impart mechanical strength such as stiffness, water resistance, chemical resistance, opacity, as required, to the in-mold label.

Examples of the thermoplastic resin, the filler, and other components to be contained in the thermoplastic resin film are all the same as described in (Recording paper), and preferable materials and preferable contents are also the same. The porosity of the substrate is also as described in (Recording paper), and preferable embodiments are also the same.

The substrate may have a single-layer structure but preferably has a multilayer structure, further preferably a multilayer structure with specific properties imparted to each layer. For example, the substrate may have a three-layer structure of first surface layer/core layer/second surface layer, and the rigidity, opacity, lightweight properties, and the like suitable for the in-mold label can be imparted to the core layer. In the first surface layer and the second surface layer, the types of the components constituting the two layers and the ratios of the structural components may be the same or different. For example, a substrate with high adhesion to the layer provided on each of both sides can be obtained by forming the first surface layer having high affinity with the underlayer and the second surface layer having high affinity with the heat sealing layer. Further, not only curling of the substrate can be prevented but also curling of the in-mold label can be controlled to within a specific range by appropriately designing the composition and the thickness of each of the first surface layer and the second surface layer. Further, a solid printing layer or a pigment-containing layer provided on the inner side of the first surface layer and the second surface layer as a hiding layer enables the visibility to be improved, without the print on the other surface seen through, as viewed from one side.

The substrate may be a non-stretched film or a stretched film. In the case where the substrate has a multilayer structure, a non-stretched film layer and a stretched film layer may be combined, or stretched films having the same or different number of stretched axes in each layer may be combined, but at least one layer thereof is preferably stretched.

The thickness of the substrate is preferably 20 μm or more, more preferably 40 μm or more, for suppressing wrinkles during printing and facilitating fixing to a proper position when inserted inside the mold. Further, the thickness of the substrate is preferably 200 μm or less, more preferably 150 μm or less, for suppressing the reduction in strength, when the in-mold label is provided on a container, due to the reduction in thickness of the container at the label boundary. Accordingly, the thickness of the substrate is preferably 20 to 200 μm, more preferably 40 to 150 μm.

### <<Underlayer>>

The in-mold label of the present invention has an underlayer between the substrate and the resin coating, which will be described below, that is, on the surface of the substrate opposed to the resin coating. The underlayer is the same as described in <<Underlayer>> of (Recording paper), and preferable embodiments are also the same.

Further, the surface of the underlayer, that is, the surface provided with the resin coating, which will be described below, may be subjected to surface treatment, as described in (Recording paper).

The indentation modulus of the underlayer is preferably 70 MPa or more, more preferably 100 MPa or more, for reducing blocking due to an increase in adhesive force of the underlayer during the production process of the in-mold label, and is preferably 1000 MPa or less, more preferably 900 MPa or less, for suppressing the reduction in adhesion to ink or toner in the printed layer.

The thickness of the underlayer is preferably 1 μm or more, more preferably 2 μm or more, for enhancing the adhesion between the substrate and the resin coating. Further, since the thickness of the in-mold label is preferably 200 μm or less, for reducing the weight of the label itself to enhance the handleability, the thickness of the underlayer is preferably 50 μm or less, more preferably 30 μm or less, in order to adjust the thickness of the in-mold label to such a range.

### <Resin Coating>

In the in-mold label of the present invention, the resin coating disposed on one surface of the laminated resin film, specifically, the surface of the underlayer provided on the substrate can be formed using an aqueous solution containing a cationic water-soluble polymer and a silane coupling agent and free from thermoplastic resin particles. Specifically, it can be formed in the same manner as the method for producing a resin coating described in (Recording paper).

Further, examples of the cationic water-soluble polymer, the silane coupling agent, the inorganic filler, and other components (such as antistatic agents, crosslinking accelerators, and anti-blocking agents) are all the same as described in (Recording paper), and preferable materials and preferable contents are also the same. The thickness of the resin coating is also as described in (Recording paper), and preferable embodiments are also the same.

Since high adhesion to the substrate is obtained, the resin coating in the present invention can also be provided on the substrate, as it is, but is provided on the substrate via the underlayer, since the adhesion is further enhanced by providing the underlayer. As a result, an in-mold label with less ink or toner detachment and excellent formation suitability can be provided even after in-mold molding.

The resin coating in the present invention has high adhesion to the heat sealing layer, which will be described below, and high adhesiveness to the PET resin. Accordingly, particularly in the case where the in-mold label of the present invention is applied to a PET resin container, the resin coating is preferably formed also on the surface of the heat sealing layer. In this case, the types and the contents of the structural components may be the same or different between the resin coating provided on the underlayer and the resin coating provided on the heat sealing layer, as long as the effects of the present invention are obtained.

### <Heat Sealing Layer>

Excellent adhesiveness to the resin container is imparted to the in-mold label by the heat sealing layer. In the in-mold molding of the container, an in-mold label is provided inside the mold so that the container and the heat sealing layer face each other. The heat sealing layer is melted by heat during in-mold molding and is thermally fused to the surface of the container.

The method for in-mold molding includes a direct blow method using a parison of a raw material resin and a stretch blow method using a preform of a raw material resin. The direct blow method is a method of forming a container by heating the raw material resin to the melting point or more to be melted, thereby forming a parison, and applying air pressure to the parison in the mold to be expanded. The stretch blow method is a method of forming a container by heating a preform previously formed from the raw material resin to about the softening point of the raw material resin, thereby stretching the preform with a rod in the mold, and applying air pressure to be expanded.

Since resin containers made of polyethylene terephthalate (PET) have low melt viscosity of PET and is difficult to maintain the shape of the parison in the molten state, the stretch blow method by heating to about the softening point instead of the melting point is generally employed for formation. Therefore, the in-mold label is thermally fused to the PET resin container also within a heating temperature range around the softening point, not the melting point of the PET resin. In the in-mold label for PET resin containers thus formed, the heat sealing layer is preferably a thermoplastic resin film having a low melting point of 60 to 130° C., for enhancing the adhesiveness to the container by sufficient melting even under low-temperature forming conditions as compared with the direct blow method of heating to the melting point or more. Since a lower melting point allows sufficient adhesiveness to be obtained with less heat, the melting point of the thermoplastic resin to be used for the heat sealing layer is more preferably 110° C. or less, further preferably 100° C. or less. Further, since a higher melting point facilitates film forming and reducing sticking to the roll during film production, the melting point of the thermoplastic resin is more preferably 70° C. or more, further preferably 75° C. or more. Accordingly, the melting point of the thermoplastic resin is more preferably 70 to 110° C., further preferably 75 to 100° C.

The melting point can be measured by a differential scanning calorimeter (DSC: Differential Scanning calorimetry).

Preferable examples of the thermoplastic resin that can be used for the heat sealing layer include low- or medium-density polyethylene with a density of 0.900 to 0.935 g/cm³, linear polyethylene with a density of 0.880 to 0.940 g/cm³, polyethylene-type resins of ethylene-vinyl acetate copolymer, ethylene-acrylic acid copolymer, ethylene-acrylic acid alkyl ester copolymer, ethylene-methacrylic acid alkyl ester copolymer with an alkyl group having 1 to 8 carbon atoms, or ethylene-methacrylic acid copolymer with a melting point of metal salts of Zn, Al, Li, K, Na, and the like of 60 to 130° C. Among these, low- or medium-density polyethylene or linear polyethylene with a degree of crystallinity, as measured by the X-ray method, of 10 to 60% and a number-average molecular weight of 10,000 to 40,000 are preferable.

For enhancing the adhesiveness and reducing blocking when in-mold labels are stacked, copolymers containing polar structural units and non-polar structural units are preferably used as the thermoplastic resin of the heat sealing layer. Examples of such copolymers include the copolymer described in International Publication No. 2018/062214.

For the heat sealing layer, one thermoplastic resin may be used singly, or two or more thermoplastic resins may be mixed for use. In the latter case, the two or more resins to be mixed preferably have high compatibility for suppressing peeling.

The heat sealing layer can contain additives that are commonly used in the field of polymers, such as tackifiers, plasticizers, antifogging agents, lubricants, anti-blocking agents, antistatic agents, antioxidants, heat stabilizers, light stabilizers, weatherproof stabilizers, and ultraviolet absorbers, as required.

The heat sealing layer may have a single-layer structure or a multilayer structure. In the case of a single-layer structure, the thickness of the heat sealing layer is preferably 0.5 μm or more, more preferably 0.7 μm or more, further preferably 1 μm or more, for enhancing the adhesiveness. Meanwhile, the thickness is preferably 10 μm or less, more preferably 3 μm or less, further preferably 2 μm or less, for suppressing the cohesive failure inside the heat sealing layer. Accordingly, the thickness of the heat sealing layer with a single-layer structure is preferably 0.5 to 10 μm, more preferably 0.7 to 3 μm, further preferably 1 to 2 μm.

In the case of further providing a resin coating on the heat sealing layer, the composition ratio (O/C) of the number of oxygen atoms (O) to the number of carbon atoms (C) on the surface of the heat sealing layer provided with the resin coating is preferably 0.01 to 0.5, for enhancing the adhesion to the resin coating. The composition ratio (O/C) is more preferably 0.03 or more, further preferably 0.05 or more, and more preferably 0.4 or less, further preferably 0.25 or less. The composition ratio (O/C) in the heat sealing layer can be controlled to the aforementioned range by the same surface treatment as in the substrate.

### <Printed Layer and Protective Layer>

As described above, the resin coating in the present invention is a recordable layer. Examples of the way of recording include recording by printing, writing tools, and the like. The in-mold label of the present invention can be used as a recording paper that can be attached to other articles by having the heat sealing layer on the opposite side to the resin coating.

Examples of the printing method are the same as described in (Recording paper). Further, a protective layer may be provided to protect the printed layer (printed surface), and the material of the protective layer is also as described above.

### <Characteristics of In-Mold Label>

### <<Thickness of In-Mold Label>>

The thickness of the in-mold label is preferably 25 μm or more, more preferably 45 μm or more, for reducing wrinkles in the label. Further, the thickness is preferably 200 μm or less, more preferably 150 μm or less, for suppressing the reduction in strength, when the in-mold label is provided on a container, due to the reduction in thickness of the container at the label boundary. Accordingly, the thickness of the in-mold label is preferably 25 to 200 μm, more preferably 45 to 150 μm.

### <<Glossiness>>

The glossiness on the surface of the resin coating in the in-mold label of the present invention can preferably maintain the gloss on the surface of the substrate. A 75-degree specular glossiness measured according to JIS P 8142:1993 can be used as the gloss.

The resin coating in the present invention is preferable also for less change in glossiness before and after in-mold molding.

### <<Haze>>

The haze of the in-mold label before the printed layer is provided is preferably low for ease of improving the transparency of the label. Further, the haze is preferably high, for ease of production. Specifically, the lower limit of the haze of the in-mold label of the present invention is preferably 1%, further preferably 2%. Meanwhile, the upper limit of the haze is preferably 10%, more preferably 5%. Here, the haze is a value measured using a haze meter according to JIS K7136:2000.

The haze can be adjusted by the type of the substrate, the thickness of the substrate, the surface shape of the substrate, the type of the material used for the resin coating, and the thickness of the resin coating.

The in-mold label of the present invention is excellent also in adhesion to liquid toner to be used particularly in the wet electrophotographic printing system and is suitable for applications for small-lot printing and variable information printing.

### (Method for Producing Recording Paper)

The method for producing a recording paper of the present invention comprises a step of applying an aqueous solution that contains a cationic water-soluble polymer and a silane coupling agent, and 9 parts by mass or less of an inorganic filler with respect to 100 parts by mass of the cationic water-soluble polymer component, as required, and is free from thermoplastic resin particles onto a laminated resin film, followed by drying, to form a resin coating on the laminated resin film.

Thus, a recording paper with a resin coating formed on at least one side of the laminated resin film can be produced.

Hereinafter, a method for producing the recording paper of the present invention will be described in detail.

The recording paper of the present invention can be produced by applying a coating solution for forming a resin coating onto at least one surface (surface on which the underlayer is formed) of a laminated resin film, followed by drying, to form a resin coating on the laminated resin film.

The productivity of the recording paper of the present invention can be improved by roll-to-roll production. Since the thickness of the resin coating can be adjusted by the coating mass of the coating solution for forming a resin coating, the desired recording paper can be produced, for example, by reducing the thickness of the resin coating while maintaining the printability.

The coating solution for forming a resin coating can be prepared by dissolving components such as the cationic water-soluble polymer and the silane coupling agent in an aqueous solvent.

The aqueous solvent may be water or may be mainly composed of water and contain a water-soluble organic solvent such as methyl alcohol, ethyl alcohol, isopropylalcohol, acetone, methyl ethyl ketone, ethyl acetate, toluene, and xylenes. To be mainly composed of water means that 50 mass % or more of the entire solvent is water. Use of an aqueous solvent facilitates process management and is preferable also in view of the safety.

The total amount of the cationic water-soluble polymer and the silane coupling agent contained in the coating solution for forming a resin coating is preferably 0.5 mass % or more, more preferably 10 mass % or more, with respect to the total amount of the coating solution for forming a resin coating in the present invention. Further, the total amount of the cationic water-soluble polymer and the silane coupling agent contained in the coating solution for forming a resin coating in the present invention is preferably 40 mass % or less, more preferably 25 mass % or less.

The application of the coating solution for forming a resin coating and the drying of the coating layer may be performed in-line together with the formation of the laminated resin film or may be performed off-line.

For applying the coating solution for forming a resin coating, coating devices such as die coaters, bar coaters, roll coaters, lip coaters, gravure coaters, spray coaters, blade coaters, reverse coaters, and air knife coaters can be used.

The coating mass of the coating solution for forming a resin coating can be appropriately adjusted in consideration of the thickness of the resin coating after drying and the concentration of the components.

For drying the coating layer, dryers such as hot air blowers and infrared dryers can be used.

It is inferred that drying the coating layer allows a dehydration condensation reaction by the silane coupling agent in the coating layer to proceed, thereby generating a resin that is a reaction product of the silane coupling agent and the cationic water-soluble polymer.

### (Method for Producing Adhesive Label)

The adhesive label of the present invention can be produced by providing an adhesive layer on a surface of the recording paper obtained by the method described in (Method for producing recording paper).

More specifically, the first underlayer and the second underlayer are first provided respectively on both surfaces of the substrate to produce a laminated resin film. Then, a recording paper is produced by applying a coating solution for forming a resin coating on each of both surfaces of the laminated resin film obtained, that is, the surfaces of the first underlayer and the second underlayer, followed by drying, to form a resin coating on each of both surfaces of the substrate. Examples of the composition, the application method, the drying method, and the like of the coating solution for forming a resin coating are as described in (Method for producing recording paper).

A pressure-sensitive adhesive may be directly applied onto a surface of the recording paper obtained for formation, or a pressure-sensitive adhesive may be applied onto a surface of the aforementioned release sheet to form an adhesive layer, and then the adhesive layer may be applied onto a surface of the recording paper.

### (Method for Producing In-Mold Label)

The method for producing an in-mold label of the present invention comprises a step of applying the aforementioned coating solution for forming a resin coating on the other side of a laminated resin film provided with a heat sealing layer on one surface, followed by drying, to form a resin coating.

The in-mold label of the present invention can be produced by roll-to-roll production to improve the productivity. Since the thickness of the resin coating can be adjusted by the coating mass of the coating solution for forming a resin coating in the present invention, a desired in-mold label can be produced, for example, by reducing the thickness of the resin coating while maintaining the printability.

<Method for Producing Laminated Resin Film with Heat Sealing Layer>

A laminated resin film provided with a heat sealing layer is obtained by laminating the heat sealing layer and the underlayer on each of both sides of the substrate. Examples of the lamination method that can be used include a coextrusion method, an extrusion laminating method, a film bonding method, and a coating method.

In the coextrusion method, lamination is performed simultaneously with formation, since a thermoplastic resin composition for the substrate, a thermoplastic resin composition for the heat sealing layer, and a thermoplastic resin composition for the underlayer (a plurality of each may be present) are supplied to multilayer dies and laminated in the multilayer dies for extrusion.

In the extrusion laminating method, formation and lamination are performed in separate steps since the substrate is previously formed, and then a melted thermoplastic resin composition for the heat sealing layer and a thermoplastic resin composition for the underlayer are laminated and nipped with rolls under cooling.

In the film bonding method, formation and lamination are performed in separate steps, since the substrate (for example, the substrate of the aforementioned recording paper), the heat sealing layer, and the underlayer are each film-formed, and then they are bonded via the pressure-sensitive adhesive.

Further, in the case where the heat sealing layer has a multilayer structure containing a non-polar resin layer and a polar resin layer, the polar resin layer can be provided by the coating method on the substrate with the non-polar resin layer laminated on one side of the substrate by the aforementioned method. Examples of the coating method can include a solvent coating method and an aqueous coating method.

Among these methods, the coextrusion method is preferable, since each layer can be firmly bonded.

Examples of the film forming method in the case of film-forming each layer singly include extrusion molding using T dies (cast forming), inflation molding using 0 dies, and calender molding using rolling rolls. As the film forming method for the substrate with a multilayer structure, the coextrusion method, the extrusion laminating method, and the like can be used.

The substrate, the heat sealing layer, and the underlayer may be non-stretched films or stretched films.

Examples of a stretching method include a longitudinal stretching method using a difference in peripheral speed within a roll group, a transverse stretching method using a tenter oven, a sequential biaxial stretching method combining the aforementioned methods, a rolling method, a simultaneous biaxial stretching method by combining a tenter oven and a pantograph, and a simultaneous biaxial stretching method by combining a tenter oven and a linear motor. Further, a simultaneous biaxial stretching (inflation molding) method of extruding a molten resin using a circular die connected to a screw extruder into a tube, followed by air inflation can also be used.

The substrate and the heat sealing layer or the underlayer may be individually stretched before laminating the layers or may be collectively stretched after lamination. Further, the stretched layers may be stretched again after lamination.

In the case where the thermoplastic resin used as each layer is an amorphous resin, the stretching temperature during stretching is preferably within the range of the glass transition temperature of the thermoplastic resin or higher. Further, in the case where the thermoplastic resin is a crystalline resin, the stretching temperature is preferably a temperature within the range of the glass transition temperature of the amorphous part of the thermoplastic resin or higher and the melting point of the crystalline part of the thermoplastic resin or lower, specifically, lower than the melting point of the thermoplastic resin by 2 to 60° C.

The stretching speed is not specifically limited but is preferably within the range of 20 to 350 m/minute for stable stretch forming.

Further, the stretch ratio for stretching the thermoplastic resin film can also be appropriately determined in consideration of characteristics or the like of the thermoplastic resin to be used. For example, in the case of stretching a thermoplastic resin film containing a homopolymer of propylene or a copolymer thereof in one direction, the stretch ratio is generally about 1.2 times or more, preferably 2 times or more, and generally 12 times or less, preferably 10 times or less. The stretch ratio in the case of biaxial stretching is generally 1.5 times or more, preferably 10 times or more, and generally 60 times or less, preferably 50 times or less, in terms of area stretch ratio.

A desired porosity is achieved, and the opacity is easily improved when the stretch ratio falls within the aforementioned ranges. Further, there is a tendency that the thermoplastic resin film is less likely to break, and stable stretch forming can be achieved.

### <Method for Forming Resin Coating>

The resin coating is formed by applying an aqueous solution that contains a cationic water-soluble polymer and a silane coupling agent, and an inorganic filler, as required, and is free from thermoplastic resin particles on the underlayer of the laminated resin film, followed by drying.

Examples of the method for forming a resin coating are as described in (Method for producing recording paper), including the composition of the coating solution for forming a resin coating.

In the case of providing a resin coating on the heat sealing layer, the resin coating may be formed in the same manner as in the case of providing a resin coating on the surface of the underlayer.

A printed layer can be provided by printing on the resin coating provided on the underlayer side.

Further, after providing a printed layer, as required, a coating solution for protective layers is applied to provide a protective layer on the outermost surface of the laminated resin film on the opposite side of the heat sealing layer.

### <<Label Processing>>

The in-mold label of the present invention is processed into a necessary shape and dimensions by cutting or punching. The cutting or punching may be performed before printing but is preferably performed after printing, for the ease of work.

### <Labeled Container>

In-mold molding of a resin container together with the in-mold label of the present invention allows a labeled container in which the in-mold label is attached to a surface of the resin container to be obtained. The underlayer and the resin coating provided thereon enable a labeled container with less peeling of ink or toner after printing or after forming to be provided. Further, the resin coating provided on the heat sealing layer enables a labeled container with high adhesiveness also to a PET resin that is different from the substrate and less peeling to be provided.

### <<Resin Container>>

The material of the resin container to which the in-mold label of the present invention can be applied is not specifically limited, and the in-mold label of the present invention can be applied, for example, to resin containers such as polyethylene resins, polypropylene resins, and PET resins.

The color of the container may be transparent or natural colors free from color materials such as pigments and dyes, or may be opaque due to color materials or coloration.

The sectional shape of the body of the container may be a perfect circle, an ellipse, or a rectangle. In the case where the sectional shape of the body is a rectangle, the corners preferably have curvatures. In view of the strength, the cross section of the body is preferably a perfect circle or an ellipse close to a perfect circle, more preferably a perfect circle.

### EXAMPLES

Hereinafter, the present invention will be described further specifically by way of examples, but the present invention is not limited to the following examples unless it exceeds the gist thereof. In the examples, the terms such as “part(s)” and “%” are described on the basis of mass, unless otherwise noted.

### (Measurement Method)

### <Thickness (μm) of Layers>

The total thickness (μm) of the laminated resin film composed of the underlayer and the substrate was measured using a constant pressure thickness measuring instrument (product name: PG-01J, available from TECLOCK Corporation) according to JIS K7130:1999. Further, the thickness (μm) of each layer in the laminated resin film was determined by cooling a measurement target sample with liquid nitrogen to a temperature of −60° C. or less, placing a razor blade (product name: Proline blade, available from Schick Japan K.K.) on the sample on a glass plate at a right angle, cutting the sample to produce a sample for cross-sectional observation, observing the cross section of the sample obtained with a scanning electron microscope (product name: JSM-6490, available from JEOL Ltd.), determining the boundary between each two thermoplastic resin compositions from the appearance of the compositions, and multiplying the total thickness of the laminated resin film by the thickness ratio of each layer observed.

### <Indentation Modulus (MPa)>

Using a nanoindentation tester ENT-2100, available from ELIONIX INC. and a Berkovich indenter (triangular pyramid tip) under the following conditions, an indentation test based on a loading-unloading test from the surface side of the underlayer (that is, the side on which the resin coating was disposed) in the laminated resin film was performed 5 times per layer, to calculate the (indentation) modulus (MPa) of the underlayer from the average of each.

### Temperature: 30° C.

Maximum load: 0.05 mN
Loading rate: 0.005 mN
Retention time at maximum load: 1 second
Surface detection method: Tilt method
Surface detection threshold coefficient: 2.0
Spring correction: None
<Surface Roughness (μm)>

The surface roughness (arithmetic mean roughness Ra (μm)) of the underlayer was measured using a three-dimensional roughness measuring device (product name: SE-3AK, available from Kosaka Laboratory Ltd.), and an analyzer (product name: SPA-11, available from Kosaka Laboratory Ltd.) according to JIS B0601: 2003.

### <Glossiness (°)>

The glossiness on the surface of the resin coating in the recording paper of the present invention preferably can maintain the surface gloss of the laminated resin film. As the glossiness, a 75-degree specular glossiness measured according to JIS P 8142:1993 was used.

### (Preparation of Resin Composition)

<Preparation of Resin Composition (a)>

A resin composition (a) composed of 80 parts by mass of propylene homopolymer (product name: NOVATEC PP FY4, available from Japan Polypropylene Corporation, MFR ((230° C., 2.16 kg load): 5 g/10 minutes, melting point: 165° C.) and 20 parts by mass of heavy calcium carbonate (product name: Softon 1800, available from BIHOKU FUNKA KOGYO CO., LTD., average particle size: 1.2 μm (measurement method: air permeation method)) was prepared.

<Preparation of Resin Composition (b)>

A resin composition (b) composed of 58 parts by mass of propylene homopolymer (product name: NOVATEC PP FY4, available from Japan Polypropylene Corporation, MFR (230° C., 2.16 kg load): 5 g/10 minutes, melting point: 165° C.), 20 parts by mass of high-density polyethylene (product name: NOVATEC HD HJ360, available from Japan Polyethylene Corporation, MFR (190° C., 2.16 kg load): 5 g/10 minutes, melting point: 132° C.), 2 parts by mass of maleic acid-modified polypropylene (product name: MODIC P908, available from Mitsubishi Chemical Corporation, softening point: 140° C.), and 20 parts by mass of heavy calcium carbonate (product name: Softon 1800, available from BIHOKU FUNKA KOGYO CO., LTD., average particle size: 1.2 μm (measurement method: air permeation method)) was prepared.

<Preparation of Resin Composition (c)>

A resin composition (c) composed of 100 parts by mass of propylene homopolymer (product name: NOVATEC PP FY4, available from Japan Polypropylene Corporation, MFR (230° C., 2.16 kg load): 5 g/10 minutes, melting point: 165° C.) was prepared.

<Preparation of Resin Composition (d)>

A resin composition (d) composed of 100 parts by mass of propylene-ethylene random copolymer (product name: NOVATEC PP FW4B, available from Japan Polypropylene Corporation, MFR (230° C., 2.16 kg load): 6.5 g/10 minutes, melting point: 140° C.) was prepared.

<Preparation of Resin Composition (e)>

A resin composition (e) composed of 100 parts by mass of olefin-type elastomer (product name: TAFMER PN PN-3560, available from Mitsui Chemicals, Inc., MFR (230° C., 2.16 kg load): 6 g/10 minutes, melting point: 160° C.) was prepared.

<Preparation of Resin Composition (f)>

A resin composition (f) composed of 100 parts by mass of long-chain low-density polyethylene (product name: NOVATEC LL UF240, available from Japan Polyethylene Corporation, MFR (190° C., 2.16 kg load): 2.1 g/10 minutes, melting point: 123° C.) was prepared.

<Preparation of Resin Composition (g)>

A resin composition (g) composed of 80 parts by mass of propylene homopolymer (product name: NOVATEC PP FY4, available from Japan Polypropylene Corporation, MFR (230° C., 2.16 kg load): 5 g/10 minutes, melting point: 165° C.) and 20 parts by mass of olefin-type elastomer (product name: TAFMER PN PN-3560, available from Mitsui Chemicals, Inc., MFR (230° C., 2.16 kg load): 6 g/10 minutes, melting point: 160° C.) was prepared.

<Preparation of Resin Composition (h)>

A resin composition (h) composed of 50 parts by mass of propylene homopolymer (product name: NOVATEC PP FY4, available from Japan Polypropylene Corporation, MFR (230° C., 2.16 kg load): 5 g/10 minutes, melting point: 165° C.) and 50 parts by mass of olefin-type elastomer (product name: TAFMER PN PN-3560, available from Mitsui Chemicals, Inc., MFR ((230° C., 2.16 kg load): 6 g/10 minutes, melting point: 160° C.) was prepared.

<Preparation of Resin Composition (i)>

A resin composition (i) composed of 20 parts by mass of propylene homopolymer (product name: NOVATEC PP FY4, available from Japan Polypropylene Corporation, MFR (230° C., 2.16 kg load): 5 g/10 minutes, melting point: 165° C.) and 80 parts by mass of olefin-type elastomer (product name: TAFMER PN PN-3560, available from Mitsui Chemicals, Inc., MFR ((230° C., 2.16 kg load): 6 g/10 minutes, melting point: 160° C.) was prepared.

Table 1 below shows the structural components of the resin compositions (a) to (i).

TABLE 1

| | Resin composition: Content ratio (parts by mass) | | | | | | | | |
|---|---|---|---|---|---|---|---|---|---|
| Contents | a | b | c | d | e | f | g | h | i |
| Propylene homopolymer (product name: NOVATEC PP FY4, | 80 | 58 | 100 | | | | 80 | 50 | 20 |
| available from Japan Polypropylene Corporation, MFR ((230° C., | | | | | | | | | |
| 2.16 kg load): 5 g/10 min, melting point: 165° C.) | | | | | | | | | |
| Propylene-ethylene random copolymer (product name: | | | | 100 | | | | | |
| NOVATEC PP FW4B, available from Japan Polypropylene | | | | | | | | | |
| Corporation, MFR (230° C., 2.16 kg load): 6.5 g/10 min, melting | | | | | | | | | |
| point: 140° C.) | | | | | | | | | |
| Olefin-type elastomer (product name: TAFMER PN PN-3560, | | | | | 100 | | 20 | 50 | 80 |
| available from Mitsui Chemicals, Inc., MFR (230° C., 2.16 kg | | | | | | | | | |
| load): 6 g/10 min, melting point: 160° C.) | | | | | | | | | |
| Long-chain low-density polyethylene (product name: | | | | | | 100 | | | |
| NOVATEC LL UF240, available from Japan Polyethylene | | | | | | | | | |
| Corporation, MFR (190° C., 2.16 kg load): 2.1 g/10 min, melting | | | | | | | | | |
| point: 123° C.) | | | | | | | | | |
| High-density polyethylene (product name: NOVATEC HD | | 20 | | | | | | | |
| HJ360, available from Japan Polyethylene Corporation, MFR | | | | | | | | | |
| (190° C., 2.16 kg load): 5 g/10 min, melting point: 132° C.) | | | | | | | | | |
| Maleic acid-modified polypropylene (product name: MODIC | | 2 | | | | | | | |
| P908, available from Mitsubishi Chemical Corporation, | | | | | | | | | |
| softening point: 140° C.) | | | | | | | | | |
| Heavy calcium carbonate (product name: Softon 1800, available | 20 | 20 | | | | | | | |
| from BIHOKU FUNKA KOGYO CO., LTD., average particle | | | | | | | | | |
| size: 1.2 μm) | | | | | | | | | |

### (Structural Components of Coating Solution for Forming Resin Coating)

### <Cationic Water-Soluble Polymer (A1) Aqueous Solution>

40 kg of isopropanol (available from Tokuyama Corporation, product name: TOKUSO IPA) was put into a reactor having an internal capacity of 150 L and equipped with a reflux condenser, a nitrogen inlet tube, a stirrer, a thermometer, a dropping funnel, and a heating jacket. Under stirring, 12.6 kg of N,N-dimethylaminoethyl methacrylate (available from Sanyo Chemical Industries, Ltd., product name: methacrylate DMA), 12.6 kg of butyl methacrylate (available from Mitsubishi Rayon Co., Ltd., product name: Acryester B), and 2.8 kg of higher alcohol methacrylate (available from Mitsubishi Rayon Co., Ltd., product name: Acryester SL, mixture of lauryl methacrylate and tridecyl methacrylate) were put therein. After the system was purged with nitrogen, and the internal temperature was raised to 80° C., 0.3 kg of 2,2′-azobisisobutyronitrile (available from Wako Pure Chemical Industries, Ltd., product name: V-60(AIBN)) as a polymerization initiator was added thereto, to initiate polymerization.

The polymerization was performed for 4 hours with the reaction temperature maintained at 80° C., and the copolymer obtained was neutralized with 4.3 kg of glacial acetic acid (available from Wako Pure Chemical Industries, Ltd). The system was purged by adding 48.3 kg of deionized water while distilling off isopropanol from the reactor, and a viscous aqueous solution of a tertiary amino group-containing methacryl polymer (weight-average molecular weight 40,000) (with a concentration of the tertiary amino group-containing methacryl polymer of 35 mass %) was obtained. The aqueous solution obtained was used as a cationic water-soluble polymer (A1) aqueous solution.

### <Cationic Water-Soluble Polymer (A2) Aqueous Solution>

A commercially available polyethyleneimine aqueous solution (available from BASF Japan Ltd., product name: Polymin SK) that is a secondary amino group-containing polymer was used as a cationic water-soluble polymer (A2) aqueous solution.

### <Silane Coupling Agent (B)>

3-Glycidoxypropyltrimethoxysilane (available from Shin-Etsu Chemical Co., Ltd., product name: KBM-403) that is a commercially available silane coupling agent was used as a silane coupling agent (B).

### <Antistatic Agent (C)>

35 parts by mass of dimethylaminoethyl methacrylate, 20 parts by mass of ethyl methacrylate, 20 parts by mass of cyclohexyl methacrylate, 25 parts by mass of stearyl methacrylate, 150 parts by mass of ethyl alcohol, and 1 part by mass of 2,2′-azobisisobutyronitrile were added into a four-necked flask with a stirring device, a reflux condenser, a thermometer, and a nitrogen gas inlet tube attached. After the system was purged with nitrogen, polymerization reaction was performed under a nitrogen stream at a temperature of 80° C. for 6 hours. Subsequently, 70 parts by mass of a 60-mass % ethyl alcohol solution of 3-chloro-2-hydroxypropylammonium chloride was added thereto, followed by further reaction at a temperature of 80° C. for 15 hours. After ethyl alcohol was distilled off while adding water dropwise, an aqueous solution of a quaternary ammonium salt-containing acrylic resin with a concentration of 30 mass % was obtained and used as an antistatic agent (C).

### <Olefin Copolymer Emulsion>

Using a twin-screw extruder (available from THE JAPAN STEEL WORKS, LTD., device name: TEX30HSS), a resin as a raw material was melt-kneading and emulsified by the following procedure to prepare an olefin copolymer emulsion.

Specifically, an ethylene-methacrylic acid-acrylate copolymer (available from Dow-Mitsui Polychemicals Company, Ltd., product name: NUCREL N035C) in the form of pellets as an olefin copolymer was supplied from a hopper to the extruder. Then, the mixture was melted and kneaded under conditions of a screw rotation speed of 230 rpm and a cylinder temperature of 160 to 250° C.

Subsequently, the cationic water-soluble polymer (A1) was continuously supplied from the inlet at the middle part of the cylinder of the extruder to give 5 parts by mass of the cationic water-soluble polymer (A1) with respect to 100 parts by mass of the olefin copolymer, thereby performing emulsification and dispersion of the olefin copolymer. Thereafter, the mixture was extruded from the outlet of the extruder, to obtain a milky aqueous dispersion. The total concentration of the cationic water-soluble polymer (A1) and the olefin copolymer was adjusted to 45 mass % by adding deionized water to the aqueous dispersion, to obtain an olefin copolymer emulsion. The volume-average particle size of the olefin copolymer particles in the emulsion, as measured using a laser diffraction particle size distribution analyzer (available from SHIMADZU CORPORATION, device name: SALD-2000), was 1.0 μm.

### <Crosslinking Agent>

An epichlorohydrin adduct of polyamine polyamide (available from Japan PMC Corporation, product name: WS-4082) was used as a crosslinking agent other than the silane coupling agent.

### <Inorganic Filler>

Calcium carbonate (product name: Softon 1800, available from BIHOKU FUNKA KOGYO CO., LTD., average particle size: 1.2 μm (measurement method: air permeation method)) was used as an inorganic filler.

### (Preparation of Coating Solution for Forming Resin Coating)

### Preparation Example 1 of Coating Solution for Forming Resin Coating (a)

An aqueous solution containing 20 parts by mass (in terms of solid content) of the cationic water-soluble polymer (A2), 20 parts by mass of the silane coupling agent (B), 20 parts by mass of the antistatic agent (C), and 2 parts by mass of an inorganic filler, with respect to 100 parts by mass (in terms of solid content) of the cationic water-soluble polymer (A1) was prepared as a coating solution for forming a resin coating (a).

In the coating solution for forming a resin coating (a), the content of the silane coupling agent (B) was 17 mass % with respect to the cationic water-soluble polymer A (including A1 and A2).

### Preparation Example 2 of Coating Solution for Forming Resin Coating (b)

An aqueous solution containing 25 parts by mass (in terms of solid content) of the cationic water-soluble polymer (A2), 30 parts by mass of the silane coupling agent (B), and 20 parts by mass of the antistatic agent (C), with respect to 100 parts by mass (in terms of solid content) of the cationic water-soluble polymer (A1) was prepared as a coating solution for forming a resin coating (b).

In the coating solution for forming a resin coating (b), the content of the silane coupling agent (B) was 24 mass % with respect to the cationic water-soluble polymer A (including A1 and A2).

### Preparation Example 3 of Coating Solution for Forming Resin Coating (c)

An aqueous solution containing 25 parts by mass (in terms of solid content) of the cationic water-soluble polymer (A2), 40 parts by mass of the silane coupling agent (B), 20 parts by mass of the antistatic agent (C), and 5 parts by mass of inorganic filler, with respect to 100 parts by mass (in terms of solid content) of the cationic water-soluble polymer (A1) was prepared as a coating solution for forming a resin coating (c).

In the coating solution for forming a resin coating (c), the content of the silane coupling agent (B) was 32 mass % with respect to the cationic water-soluble polymer A (including A1 and A2).

### Preparation Example 4 of Coating Solution for Forming Resin Coating (d)

As shown in Table 2, an aqueous solution containing 5 parts by mass of the cationic water-soluble polymer (A2), 5 parts by mass of the silane coupling agent (B), 5 parts by mass of the antistatic agent (C), and 2 parts by mass of inorganic filler, with respect to 100 parts by mass (in terms of solid content) of the olefin copolymer emulsion was prepared as a coating solution for forming a resin coating (d).

In the coating solution for forming a resin coating (d), the content of the silane coupling agent (B) was 100 mass % with respect to the cationic water-soluble polymer A (including A1 and A2).

### Preparation Example 5 of Coating Solution for Forming Resin Coating (e)

A coating solution for forming a resin coating (e) was prepared in the same manner as the coating solution for forming a resin coating (d) except that the olefin copolymer emulsion was not used, and 5 parts by mass of a crosslinking agent was further used instead of 5 parts by mass of the silane coupling agent (B) in the coating solution for forming a resin coating (d).

In the coating solution for forming a resin coating (e), the content of the silane coupling agent (B) was 0 mass % with respect to the cationic water-soluble polymer A (including A1 and A2).

### Preparation Example 6 of Coating Solution for Forming Resin Coating (f)

A coating solution for forming a resin coating (f) was prepared in the same manner as the coating solution for forming a resin coating (b) except that 12 parts by mass of an inorganic filler was contained in the coating solution for forming a resin coating (b).

In the coating solution for forming a resin coating (f), the content of the silane coupling agent (B) was 24 mass % with respect to the cationic water-soluble polymer A (including A1 and A2).

### Preparation Example 7 of Coating Solution for Forming Resin Coating (g)

An aqueous solution containing 50 parts by mass (in terms of solid content) of the cationic water-soluble polymer (A2), 45 parts by mass of the silane coupling agent (B), 20 parts by mass of the antistatic agent (C), and 0.1 parts by mass of inorganic filler, with respect to 50 parts by mass (in terms of solid content) of the cationic water-soluble polymer (A1) was prepared as a coating solution for forming a resin coating (g).

In the coating solution for forming a resin coating (g), the content of the silane coupling agent (B) was 45 mass % with respect to the cationic water-soluble polymer A (including A1 and A2).

### Preparation Example 8 of Coating Solution for Forming Resin Coating (h)

An aqueous solution containing 60 parts by mass (in terms of solid content) of the cationic water-soluble polymer (A2), 53 parts by mass of the silane coupling agent (B), 30 parts by mass of the antistatic agent (C), and 0.1 parts by mass of inorganic filler, with respect to 40 parts by mass (in terms of solid content) of the cationic water-soluble polymer (A1) was prepared as a coating solution for forming a resin coating (h).

In the coating solution for forming a resin coating (h), the content of the silane coupling agent (B) was 53 mass % with respect to the cationic water-soluble polymer A (including A1 and A2).

### Preparation Example 9 of Coating Solution for Forming Resin Coating (i)

A coating solution for forming a resin coating (i) was prepared in the same manner as the coating solution for forming a resin coating (h) except that the content of the silane coupling agent (B) was changed to 60 parts by mass, the content of the antistatic agent (C) was changed to 15 parts by mass, and the content of the inorganic filler was changed to 1.0 part by mass in the coating solution for forming a resin coating (h).

In the coating solution for forming a resin coating (i), the content of the silane coupling agent (B) was 60 mass % with respect to the cationic water-soluble polymer A (including A1 and A2).

### Preparation Example 10 of Coating Solution for Forming Resin Coating (j)

A coating solution for forming a resin coating (j) was prepared in the same manner as the coating solution for forming a resin coating (h) except that the content of the silane coupling agent (B) was changed to 65 parts by mass, the content of the antistatic agent (C) was changed to 15 parts by mass, and the content of the inorganic filler was changed to 1.0 part by mass in the coating solution for forming a resin coating (h).

In the coating solution for forming a resin coating (j), the content of the silane coupling agent (B) was 65 mass % with respect to the cationic water-soluble polymer A (including A1 and A2).

Table 2 below shows Preparation Examples 1 to 6 of the coating solutions for forming resin coatings (a) to (j).

TABLE 2

| | | Resin coating | | | | | | | |
|---|---|---|---|---|---|---|---|---|---|
| | | | | Silane | | | | | |
| | Coating | Cationic water-soluble | | coupling | Antistatic | | | | Content of (B) with |
| | solution for | polymer | | agent | agent | | Crosslinking | Inorganic | respect to (A) |
| | forming | (A1) | (A2) | (B) | (C) | Olefin polymer | agent | filler | (including A1 and |
| | resin | [parts by | [parts by | [parts by | [parts by | emulsion | [parts by | [parts by | A2) |
| | coating | mass] | mass] | mass] | mass] | [parts by mass] | mass] | mass] | [mass %] |
| Preparation | (a) | 100 | 20 | 20 | 20 | 0 | 0 | 2 | 17 |
| Example 1 | | | | | | | | | |
| Preparation | (b) | 100 | 25 | 30 | 20 | 0 | 0 | 0 | 24 |
| Example 2 | | | | | | | | | |
| Preparation | (c) | 100 | 25 | 40 | 20 | 0 | 0 | 5 | 32 |
| Example 3 | | | | | | | | | |
| Preparation | (d) | 0 | 5 | 5 | 5 | 100 | 0 | 2 | 100 |
| Example 4 | | | | | | | | | |
| Preparation | (e) | 0 | 5 | 0 | 5 | 0 | 5 | 2 | 0 |
| Example 5 | | | | | | | | | |
| Preparation | (f) | 100 | 25 | 30 | 20 | 0 | 0 | 12 | 24 |
| Example 6 | | | | | | | | | |
| Preparation | (g) | 50 | 50 | 45 | 20 | 0 | 0 | 0.1 | 45 |
| Example 7 | | | | | | | | | |
| Preparation | (h) | 40 | 60 | 53 | 30 | 0 | 0 | 0.1 | 53 |
| Example 8 | | | | | | | | | |
| Preparation | (i) | 40 | 60 | 60 | 15 | 0 | 0 | 1.0 | 60 |
| Example 9 | | | | | | | | | |
| Preparation | (j) | 40 | 60 | 65 | 15 | 0 | 0 | 1.0 | 65 |
| Example 10 | | | | | | | | | |

### Production Examples of Recording Paper

### Production of Laminated Resin Film

### Production Example 1 of Laminated Resin Film

The resin composition (a) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group.

Then, the resin composition (d) was melt-kneaded in an extruder set to 250° C., then extruded in the form of a sheet, and laminated on the first surface of a resin layer composed of the resin composition (a).

Then, the resin composition (a) was melt-kneaded in an extruder set to 250° C., then extruded in the form of a sheet, and laminated on the second surface opposite to the first surface of the resin layer composed of the resin composition (a) previously formed.

Thus, a laminated sheet in which three layers of the resin layer composed of the resin composition (d), the resin layer composed of the resin composition (a), and the resin layer composed of the resin composition (a) were laminated was obtained.

Then, this three-layer laminated sheet was cooled to 60° C., the laminated sheet was heated to about 150° C. using a tenter oven, stretched 8.5 times in the transverse direction, and then further heated to 160° C. for heat treatment.

Then, after cooling to 60° C., the ear parts were slit, to obtain a laminated resin film with a thickness of 80 μm, each layer having a resin composition (d/a/a), each layer having a thickness (5 μm/60 μm/15 μm), and each layer having the number of stretched axes (uniaxial/biaxial/uniaxial).

In the laminated resin film, the resin layer composed of the resin composition (d) corresponds to the aforementioned underlayer. Further, the laminated resin film has a substrate composed of two layers, in which the biaxially stretched layer composed of the resin composition (a) corresponds to the core layer, and the uniaxially stretched layer composed of the resin composition (a) corresponds to the surface layer.

### Production Examples 2 to 6 and 8 to 19 of Laminated Resin Film

Laminated resin films as the laminated resin films of Production Examples 2 to 6 and 8 to 19 were obtained in the same manner as in Production Example 1 of the laminated resin film except that each resin layer was changed as shown in Table 3 below in Production Example 1 of the laminated resin film.

### Production Example 7 of Laminated Resin Film

The resin composition (a) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group.

Then, the resin layer composed of the resin composition (a) was cooled to 60° C., heated to about 150° C. using a tenter oven, stretched 8.5 times in the transverse direction, and then further heated to 160° C. for heat treatment.

Then, after cooling to 60° C., the ear parts were slit, to obtain a monolayer biaxially stretched sheet with a thickness of 60 μm.

Then, the resin composition (c) was melt-kneaded in each of two extruders set to 250° C., then extruded in the form of a sheet, and laminated on the first surface of the resin layer composed of the resin composition (a) and simultaneously on the second surface thereof, to obtain a laminated sheet with the three layers laminated.

Then, after cooling to 60° C., the ear parts were slit, to obtain a laminated resin film with a thickness of 100 μm, each layer having a resin composition (c/a/c), each layer having a thickness (20 μm/60 μm/20 μm), and each layer having the number of stretched axes (unstretched/biaxial/unstretched).

In the laminated resin film, the resin layer composed of the resin composition (c) and laminated on the first surface of the biaxially stretched resin layer composed of the resin composition (a) corresponds to the aforementioned underlayer. Further, the laminated resin film has a substrate composed of two layers, in which the biaxially stretched layer composed of the resin composition (a) corresponds to the core layer, and the layer composed of the resin composition (c) and laminated on the second surface of the biaxially stretched resin layer composed of the resin composition (a) corresponds to the surface layer.

Table 3 below shows the measurement results for the laminated resin films obtained in Production Examples 1 to 19.

TABLE 3

| | Recording Paper | | | | | | | | | |
|---|---|---|---|---|---|---|---|---|---|---|
| | Laminated resin film | | | | | | | | | |
| | Underlayer | | | | | | | | | |
| | | | | Surface | | Core layer | Surface layer | | | |
| | Resin | Thickness | Modulus | roughness | Glossiness | Resin | Resin | Thickness | | Thickness |
| | composition | [μm] | [MPa] | [μm] | [°] | composition | composition | [μm] | Stretch | [μm] |
| Production | d | 5 | 900 | 0.2 | 70 | a | a | 15 | Uniaxial/Biaxial/ | 5/60/15 |
| Example 1 | | | | | | | | | Uniaxial | |
| Production | e | 5 | 200 | 0.2 | 65 | a | a | 15 | Uniaxial/Biaxial/ | 5/60/15 |
| Example 2 | | | | | | | | | Uniaxial | |
| Production | f | 5 | 350 | 0.2 | 60 | a | a | 15 | Uniaxial/Biaxial/ | 5/60/15 |
| Example 3 | | | | | | | | | Uniaxial | |
| Production | g | 5 | 1050 | 0.1 | 82 | a | a | 15 | Uniaxial/Biaxial/ | 5/60/15 |
| Example 4 | | | | | | | | | Uniaxial | |
| Production | h | 5 | 540 | 0.2 | 54 | a | a | 15 | Uniaxial/Biaxial/ | 5/60/15 |
| Example 5 | | | | | | | | | Uniaxial | |
| Production | i | 5 | 280 | 0.2 | 50 | a | a | 15 | Uniaxial/Biaxial/ | 5/60/15 |
| Example 6 | | | | | | | | | Uniaxial | |
| Production | c | 20 | 700 | 0.2 | 67 | a | c | 20 | Unstretched/Biaxial/ | 20/60/20 |
| Example 7 | | | | | | | | | Unstretched | |
| Production | b | 10 | 1200 | 0.6 | 20 | a | a | 10 | Uniaxial/Biaxial/ | 10/60/10 |
| Example 8 | | | | | | | | | Uniaxial | |
| Production | d | 5 | 900 | 0.2 | 70 | a | a | 15 | Uniaxial/Biaxial/ | 5/60/15 |
| Example 9 | | | | | | | | | Uniaxial | |
| Production | a | 5 | 1600 | 0.6 | 20 | a | a | 5 | Uniaxial/Biaxial/ | 5/60/15 |
| Example 10 | | | | | | | | | Uniaxial | |
| Production | c | 5 | 1500 | 0.1 | 90 | a | a | 5 | Uniaxial/Biaxial/ | 5/60/15 |
| Example 11 | | | | | | | | | Uniaxial | |
| Production | e | 5 | 160 | 0.2 | 63 | a | a | 5 | Uniaxial/Biaxial/ | 5/60/15 |
| Example 12 | | | | | | | | | Uniaxial | |
| Production | e | 5 | 150 | 0.2 | 65 | a | a | 5 | Uniaxial/Biaxial/ | 5/60/15 |
| Example 13 | | | | | | | | | Uniaxial | |
| Production | b | 10 | 1200 | 0.6 | 20 | a | a | 10 | Uniaxial/Biaxial/ | 10/60/10 |
| Example 14 | | | | | | | | | Uniaxial | |
| Production | e | 5 | 200 | 0.2 | 65 | a | a | 15 | Uniaxial/Biaxial/ | 5/60/15 |
| Example 15 | | | | | | | | | Uniaxial | |
| Production | d | 5 | 900 | 0.2 | 70 | a | a | 15 | Uniaxial/Biaxial/ | 5/60/15 |
| Example 16 | | | | | | | | | Uniaxial | |
| Production | d | 5 | 900 | 0.2 | 70 | a | a | 15 | Uniaxial/Biaxial/ | 5/60/15 |
| Example 17 | | | | | | | | | Uniaxial | |
| Production | d | 5 | 900 | 0.2 | 70 | a | a | 15 | Uniaxial/Biaxial/ | 5/60/15 |
| Example 18 | | | | | | | | | Uniaxial | |
| Production | d | 5 | 900 | 0.2 | 70 | a | a | 15 | Uniaxial/Biaxial/ | 5/60/15 |
| Example 19 | | | | | | | | | Uniaxial | |

### Production of Recording Paper

### Example 1

Both sides of the laminated resin film obtained in Production Example 1 of the laminated resin film were subjected to corona discharge treatment under the condition of 30 W·minute/m², and then the coating solution for forming the resin coating (a) prepared in Preparation Example 1 of the coating solution for forming a resin coating was applied thereto using a roll coater so that the thickness after drying of each surface was 0.03 μm. The coating layer was dried in an oven at 60° C. to form a resin coating, thereby obtaining a recording paper.

### Examples 2 to 12 and Comparative Examples 1 to 7

Recording papers of Examples 2 to 12 and Comparative Examples 1 to 7 were obtained in the same manner as in Example 1 except that the laminated resin film and the resin coating in Example 1 were changed as shown in Table 4.

### Evaluation

The recording papers obtained in Examples 1 to 7 and 9 to 12 and Comparative Examples 1 to 4, 6, and 7 were evaluated as follows.

### <Anti-Blocking Property 1>

The recording paper obtained in each of Examples and Comparative Examples was wound into a roll to be stored for one day in an atmosphere at a temperature of 40° C. and a relative humidity of 50% and then evaluated for take-up blocking by the following method to confirm whether smooth withdrawal was possible without blocking when withdrawing the paper from the roll.

Good: Smooth withdrawal without peeling sound
Fair: Not impaired appearance of laminated resin film after take-up with peeling sound (lower limit of practical use)
Poor: Impaired appearance of laminated resin film after take-up with significant peeling sound (not suitable for practical use)

### <Anti-Blocking Property 2>

Each two pieces of the recording paper obtained in each of Examples and Comparative Examples were stacked so that the resin coatings were in contact with each other, held in a heat gradient tester (TYPE HG-100, available from Toyo Seiki Seisaku-sho, Ltd.), and pressure-bonded for 5 minutes with a temperature setting of 30 to 50° C. in 5° C. increments, to determine the thermal roll fusion according to the following evaluation criteria.

Good: Not bonded at 40° C. or more and 50° C. or less
Fair: Not bonded at 30° C. or more and less than 40° C. (lower limit of practical use)
Poor: Bonded at less than 30° C. (not suitable for practical use)

### Printability by Wet Electrophotographic Printing System

Then, the recording papers obtained in Examples 1 to 7 and 9 to 12 and Comparative Examples 1 to 4, 6, and 7 were evaluated for printability by the following method.

First, the recording paper obtained in each of Examples and Comparative Examples was humidified in an environment at a temperature of 23° C. and a relative humidity of 50% for 3 hours. Then, under the same environment as in humidification, an ink solid image with a density of 100% and a black halftone dot pattern with a density of 30% were each printed on one side of the recording paper, using a wet electrophotographic printing machine (device name: Indigo7800, available from HP Japan Inc.). The printer was equipped with multi-color liquid toner (available from Hewlett-Packard Japan, Ltd., product name: HP ElectroInk Light Cyan Q4045A, HP ElectroInk Light Magenta Q4046A, HP ElectroInk Digital Matt 4.0, 3 Cartridges Q4037A, HP ElectroInk Digital Matt 4.0, 9 Cartridges Q4038A).

### <Toner Transferability>

The state of each image on the recording paper after printing was enlarged using a loupe and visually observed, and the toner transferability was evaluated as follows.

Good: Clear image with good toner transferability
Fair: Not clear ink blots visually, but dot area observed with loupe (lower limit of practical use)
Poor: Faint image with low toner transferability (not suitable for practical use)

### <Toner Adhesion>

The recording paper printed by the aforementioned procedure was immersed in water at 23° C. for 24 hours, then taken out of water, and lightly wiped off with a waste cloth to remove moisture. 5 minutes later, the adhesive surface of an adhesive tape (product name: Cellotape (R) CT-18, available form NICHIBAN CO., LTD.) was attached to the printed surface of the recording paper and closely contacted sufficiently by rubbing it three times with a finger. After the closely contacted adhesive tape was peeled off by hand at a speed of 300 m/min in the direction of 180 degrees, the ink remaining proportion on the recording paper was calculated using a compact general-purpose image analyzer (available from NIRECO CORPORATION, model name: LUZEX-AP). Specifically, the image obtained by capturing the printed surface was binarized, and the area proportion of the toner was calculated as a remaining proportion. From the ink remaining proportion calculated, the adhesion of ink was ranked according to the following criteria.

Good: Toner remaining proportion of 80% or more
Fair: Toner remaining proportion of 50% or more and less than 80% (lower limit of practical use)
Poor: Toner remaining proportion of less than 50% (not suitable for practical use)

### <Scratch Resistance: Wet A>

Each recording paper printed by the aforementioned procedure was set in a Gakushin-type dyeing friction fastness tester (available from Suga Test Instruments Co., Ltd., device name: friction tester Type II), followed by a friction test of rubbing against a white cotton cloth moistened in water 100 times with a load of 500 g. The scratch resistance was evaluated from the toner remaining proportion on the recording paper after the friction test according to the same criteria as in the evaluation of the toner adhesion.

### <Scratch Resistance: Wet B>

Each recording paper printed by the aforementioned procedure was immersed in water at 23° C. for 24 hours. Thereafter, it was taken out of the water, and moisture was lightly wiped off with a waste cloth. The friction test and the evaluation were performed 5 minutes later in the same manner as in the scratch resistant wet conditions A.

### <Change in Gloss in Printing>

One piece of the recording paper was held in a heat gradient tester (TYPE HG-100, available from Toyo Seiki Seisaku-sho, Ltd.), so that the printed surface was pressurized, and pressurization was performed for 5 seconds at a temperature setting of 90 to 170° C. in 20° C. increments. The 75-degree specular glossiness of the pressurized portion was measured according to JIS P 8142:1993, and the change in gloss in printing was determined from the difference from the glossiness of unpressurized recording paper, based on the following evaluation criteria.

Good: Glossiness difference of less than 5% at 130° C. or more and less than 170° C.
Fair: Glossiness difference of less than 10% at 100° C. or more and less than 130° C. (lower limit of practical use)
Poor: Glossiness difference of 10% or more at less than 100° C. (not suitable for practical use)

### <Light Resistance>

In applications such as posters, there may be a problem that ink of UV ink printings peels off due to outdoor use. However, when an exposure test is actually conducted outdoors to evaluate the weather resistance, the results tend to fluctuate due to various fluctuation factors such as climate and weather. In this description, printings were subjected to weather resistance-accelerated treatment (exposure test) under uniform conditions according to JIS K-7350-4, and then the adhesion of the UV ink printings was evaluated. More specifically, the accelerated treatment was performed under the following conditions.

A super accelerated weathering tester (product name “METAL WEATHER KU-R5N-A”, available from DAIPLA WINTES CO., LTD., metal halide lamp-type) and a glass filter “KF-2 filter” (product name) transmitting ultraviolet light at 295 to 450 nm were used. The four corners of a test specimen obtained by cutting the recording paper printed by the aforementioned procedure into dimensions of 90 mm×150 mm were attached and fixed to a stainless steel plate (100 mm×200 mm) with an aluminum foil tape “AL-T” (product name, available from TAKEUCHI INDUSTRY CO., LTD.) so that the printed surface was exposed, and the plate was set in the tester. The irradiance of the surface of the test specimen was set to 90 W/m², and the black panel temperature was set to 63° C. Exposure at a temperature of 63° C. and a relative humidity of 50% for 5 hours and exposure at a temperature of 30° C. and a relative humidity of 98% for 3 hours were taken as one cycle, and two cycles were conducted for accelerated treatment. Accordingly, the amount of radiation exposure on the printed surface was 5.18×10⁶ J/m².

Then, a friction test and evaluation were conducted on the test specimen subjected to the weather resistance-accelerated treatment in the same manner as in <Scratch resistance: wet A>.

Table 4 below shows the evaluation results of Examples 1 to 7 and 9 to 12 and Comparative Examples 1 to 4, 6, and 7.

TABLE 4

| | | | | Printability | | | | | |
|---|---|---|---|---|---|---|---|---|---|
| | | | | | | | | Change in | |
| Recording | | Anti-blocking | Anti-blocking | Toner | | Scratch resistance | | gloss in | |
| paper | Laminated resin film | property 1 | property 2 | transferability | Toner adhesion | Wet A | Wet B | printing | Light resistance |
| Example 1 | Production Example 1 | Good | Good | Good | Good | Good | Good | Good | Good |
| Example 2 | Production Example 2 | Fair | Fair | Good | Good | Good | Good | Good | Good |
| Example 3 | Production Example 3 | Good | Good | Fair | Good | Good | Good | Good | Good |
| Example 4 | Production Example 4 | Fair | Good | Good | Good | Good | Good | Good | Good |
| Example 5 | Production Example 5 | Good | Good | Fair | Good | Good | Good | Good | Good |
| Example 6 | Production Example 6 | Fair | Good | Good | Good | Good | Good | Good | Good |
| Example 7 | Production Example 7 | Good | Good | Good | Good | Good | Good | Good | Good |
| Example 9 | Production Example 9 | Good | Good | Good | Good | Good | Good | Good | Good |
| Example 10 | Production Example 16 | Good | Good | Good | Good | Good | Good | Good | Good |
| Example 11 | Production Example 17 | Good | Good | Good | Good | Good | Good | Good | Good |
| Example 12 | Production Example 18 | Good | Good | Good | Fair | Good | Good | Good | Good |
| Comparative | Production Example 10 | Good | Good | Good | Good | Good | Good | Good | Good |
| Example 1 | | | | | | | | | |
| Comparative | Production Example 11 | Fair | Good | Good | Fair | Good | Fair | Good | Poor |
| Example 2 | | | | | | | | | |
| Comparative | Production Example 12 | Fair | Good | Good | Fair | Good | Poor | Good | Poor |
| Example 3 | | | | | | | | | |
| Comparative | Production Example 13 | Good | Poor | Good | Good | Good | Poor | Poor | Poor |
| Example 4 | | | | | | | | | |
| Comparative | Production Example 15 | Good | Fair | Poor | Poor | Fair | Poor | Fair | Poor |
| Example 6 | | | | | | | | | |
| Comparative | Production Example 19 | Good | Good | Good | Poor | Good | Good | Good | Good |
| Example 7 | | | | | | | | | |

### Printability in the Aqueous Ink-Jet Printing System

The recording papers obtained in Example 8 and Comparative Example 5 were evaluated for printability in the aqueous ink-jet printing system.

For <Water absorption>, a white recording paper was used, and for other items, an aqueous pigment ink-jet printer (model name: TM-C3500, available from SEIKO EPSON CORPORATION) and the printer standard cyan, magenta, yellow, and black aqueous pigment inks (model number: SJIC22) were used, to evaluate the printability in the aqueous ink-jet printing system.

### <Water Absorption>

For the recording papers obtained in Example 8 and Comparative Example 5, the water absorption of the resin coating was measured. The water absorption was determined by keeping contact for 120 seconds and then measuring the water absorption using a Cobb Sizing Tester (available from KUMAGAI RIKI KOGYO Co., Ltd.) according to the Cobb method (JIS P8140:1998), and an average of data at three points was taken as a measured value.

### <Blots>

N5 pattern of JIS X9201: 2001 (high-definition color digital standard image (CMYK/SCID)) was printed on one side of each of the recording papers obtained in Example 8 and Comparative Example 5, using the aforementioned printer by the ink-jet system. The image printed by the aqueous pigment ink-jet printer was visually observed immediately after printing, and dots in the image were observed with a microscope, to determine the blots as follows.

Good: No blots observed
Fair: Thick or not clear line contour with some blots observed (lower limit of practical use)
Poor: Blots observed throughout image (not suitable for practical use)

### <Dryness>

Paper was pressed against the image printed by the aforementioned procedure immediately after printing, to determine the ink dryness, as follows.

Good: No ink visually observed on surface as liquid, and no ink transferred to paper when lightly pressed

Fair: No ink visually observed on surface as liquid, but ink of entire image transferred to paper when pressed (lower limit of practical use)
Poor: Ink visually observed on surface as liquid (not suitable for practical use)

### <Scratch Resistance>

The image portion printed by the aforementioned procedure was cut out into a size of 30 mm×120 mm one day after printing and set in a Gakushin tester (available from Suga Test Instruments Co., Ltd). As an evaluation under dry conditions, a gauze dried at room temperature was attached to a weight with a load of 215 g, and the surface of the printed image portion was rubbed 100 times with the weight, to evaluate the degree of ink peeling by visual observation. Further, as an evaluation under wet conditions, a gauze soaked with 20 μL of pure water at room temperature was attached to a weight with a load of 215 g, and the surface of the printed image portion was rubbed 100 times with the weight, to evaluate the degree of ink peeling by visual observation. The evaluation criteria were as shown below, which were the same under both dry and wet conditions.

Good: Remaining proportion of rubbed image portion of 95% or more
Fair: Remaining proportion of rubbed image portion of 80% or more and less than 95% (lower limit of practical use)
Poor: Remaining proportion of rubbed image portion of less than 80% (not suitable for practical use)

Table 5 below shows the evaluation results of Example 8 and Comparative Example 5.

TABLE 5

| | | Printability | | | | |
|---|---|---|---|---|---|---|
| | | Aqueous ink-jet | | | | |
| | | Water | | | | |
| | | absorption | | | Scratch resistance | |
| Recording paper | Laminated resin film | [ml/m²] | Blots | Dryness | Dry | Wet |
| Example 8 | Production | 15 | Good | Good | Good | Good |
| | Example 8 | | | | | |
| Comparative | Production | 15 | Fair | Good | Good | Poor |
| Example 5 | Example 14 | | | | | |

As shown in Table 4, it was confirmed that the recording papers of Examples had good printability in all of toner transferability, toner adhesion, and scratch resistance even in the case where printing was performed by the wet electrophotographic printing system using liquid toner. Since the results were good even under wet conditions, it is understood that the water resistance is particularly excellent. Further, since the recording papers of Examples were excellent in anti-blocking property and weather resistance, it is understood that blocking and change in paper quality are less likely to occur when printings are stored at high temperature. Further, it was also confirmed that change in gloss before and after printing was small.

Further, it was confirmed that the recording papers of Examples had good printability in all of blots, dryness, and scratch resistance, and blocking was less likely to occur, as shown in Table 5, even in the case where printing was performed by the aqueous ink-jet printing system.

That is, it is understood that the recording papers of Examples have high adhesion, particularly, high water resistant adhesion, without ink transfer failure, reduction in ink adhesion of printings, blocking, and change in paper quality after printing.

Meanwhile, it was confirmed that the recording papers of Comparative Examples could allow toner transferability and adhesion to be obtained, but the adhesion decreased under wet conditions, resulting in a reduction in water resistance and weather resistance when containing olefin-type copolymer particles. Further, the resin coatings free from silane coupling agents and cationic water-soluble polymers could not achieve sufficient printability in any printing system.

Further, the resin coatings with an excessive content of silane coupling agent component were too hard to achieve sufficient toner adhesion, due to concentration of stress at the interface between each resin coating and toner.

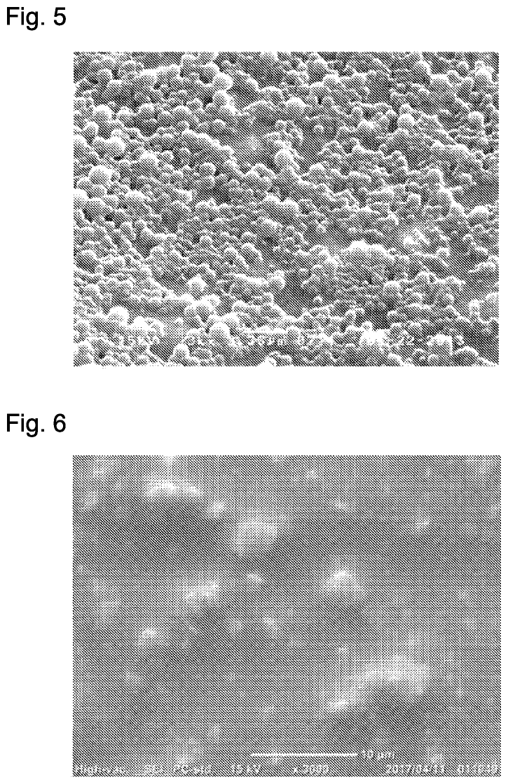

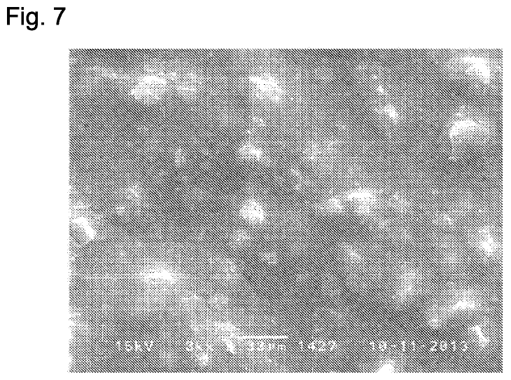

FIG. 5 to FIG. 7 respectively show images of a surface of the recording paper of Comparative Example 3, a surface of the recording paper of Example 1, and a surface of the laminated resin film before forming the resin coating, after vapor deposition of gold, as captured with a scanning electron microscope. The images of FIG. 5 and FIG. 7 were captured using a scanning electron microscope (model number: SM-200) available from TOPCON CORPORATION, and the image of FIG. 6 was captured using a scanning electron microscope (model number: JCM-6000) available from JEOL Ltd. The magnification during capture was 3000 times in all cases.

As shown in FIG. 5, it can be seen that the surface of Comparative Example 3 has many microasperities and is fluffed easily. It is considered that these asperities are derived from the olefin copolymer particles. Meanwhile, as shown in FIG. 6, it can be seen that the surface of Example 1 has less asperities and has a surface structure in which fluffing is less likely to occur. As FIG. 6 is compared with FIG. 7 that is a captured image of the laminated resin film, large granules can be confirmed in both images, and the granules are considered to be the filler in the laminated resin film shown in FIG. 7.

### Examples of Adhesive Label

### Production of Laminated Resin Film

### Production Example 21 of Laminated Resin Film

The resin composition (a) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group.

Then, the resin composition (e) was melt-kneaded in an extruder set to 250° C., then extruded in the form of a sheet, and laminated on the first surface of a resin layer composed of the resin composition (a).

Then, the resin composition (d) was melt-kneaded in an extruder set to 250° C., then extruded in the form of a sheet, and laminated on the second surface opposite to the first surface of the resin layer composed of the resin composition (a).

Thus, a laminated sheet in which three layers of the resin layer composed of resin composition (e), the resin layer composed of the resin composition (a), and the resin layer composed of the resin composition (d) were laminated was obtained.

Then, this three-layer laminated sheet was cooled to 60° C., and the laminated sheet was heated to about 150° C. using a tenter oven to be stretched 8.5 times in the transverse direction and then further heated to 160° C. for heat treatment.

Then, after cooling to 60° C., the ear parts were slit, to obtain a laminated resin film with a thickness of 80 μm, each layer having a resin composition (e/a/d), each layer having a thickness (10 μm/60 μm/10 μm), and each layer having the number of stretched axes (uniaxial/biaxial/uniaxial).

The adhesive layer was disposed on the side of the resin layer composed of the resin composition (d) in the aforementioned laminated resin film, as described later. That is, in the aforementioned laminated resin film, the resin layer composed of resin composition (e) corresponds to the first underlayer, and the resin layer composed of the resin composition (d) corresponds to the second underlayer, respectively.

### Production Example 22 of Laminated Resin Film

The resin composition (a) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group.

Then, the resin composition (e) was melt-kneaded in each of two extruders set to 250° C., then extruded in the form of a sheet, and laminated on the first surface of the resin layer composed of the resin composition (a) and on the second surface thereof at the same time, to obtain a laminated sheet with the three layers laminated.

Then, this three-layer laminated sheet was cooled to 60° C., and the laminated sheet was heated to about 150° C. using a tenter oven to be stretched 8.5 times in the transverse direction and then further heated to 160° C. for heat treatment.

Then, after cooling to 60° C., the ear parts were slit, to obtain a laminated resin film with a thickness of 80 μm, each layer having a resin composition (e/a/e), each layer having a thickness (10 μm/60 μm/10 μm), and each layer having the number of stretched axes (uniaxial/biaxial/uniaxial).

### Production Examples 23 to 26 and 28 to 37 of Laminated Resin Film

Laminated resin films as the laminated resin films of Production Examples 23 to 26 and 28 to 37 were obtained in the same manner as in Production Example 2 of the laminated resin film except that each resin layer in Production Example 2 of the laminated resin film was changed as shown in Table 6 below.

### Production Example 27 of Laminated Resin Film

The resin composition (c) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group.

Then, the resin layer composed of the resin composition (c) was cooled to 60° C., heated to about 150° C. using a tenter oven, stretched 8.5 times in the transverse direction, and then further heated to 160° C. for heat treatment.

Then, after cooling to 60° C., the ear parts were slit, to obtain a monolayer biaxially stretched sheet with a thickness of 60 μm.

Then, the resin composition (c) was melt-kneaded in each of two extruders set to 250° C., then extruded in the form of a sheet, and laminated on the first surface of the monolayer biaxially stretched sheet of the resin layer composed of the resin composition (c) and on the second surface thereof at the same time, to obtain a laminated sheet with the three layers laminated.

Then, after cooling to 60° C., the ear parts were slit, to obtain a laminated resin film with a thickness of 80 μm, each layer having a resin composition (c/c/c), each layer having a thickness (20 μm/60 μm/20 μm), and each layer having the number of stretched axes (unstretched/biaxial/unstretched).

Table 6 below shows the measurement results of the laminated resin films obtained in Production Examples 21 to 37.

TABLE 6

| | Recording paper | | | | | | | | |
|---|---|---|---|---|---|---|---|---|---|
| | Laminated resin film | | | | | | | | |
| | First underlayer | | | | Second underlayer | | | | |
| | | | Surface | Core layer | | | Surface | | |
| | Resin | Modulus | roughness | Resin | Resin | Modulus | roughness | | Thickness |
| | composition | [MPa] | [μm] | composition | composition | [MPa] | [μm] | Stretch | [μm] |
| Production | e | 160 | 0.2 | a | d | 880 | 0.2 | Uniaxial/Biaxial/Uniaxial | 10/60/10 |
| Example 21 | | | | | | | | | |
| Production | e | 140 | 0.2 | a | e | 150 | 0.2 | Uniaxial/Biaxial/Uniaxial | 10/60/10 |
| Example 22 | | | | | | | | | |
| Production | f | 410 | 0.2 | a | f | 400 | 0.2 | Uniaxial/Biaxial/Uniaxial | 10/60/10 |
| Example 23 | | | | | | | | | |
| Production | g | 1050 | 0.1 | a | g | 1000 | 0.1 | Uniaxial/Biaxial/Uniaxial | 10/60/10 |
| Example 24 | | | | | | | | | |
| Production | h | 540 | 0.1 | a | h | 520 | 0.1 | Uniaxial/Biaxial/Uniaxial | 10/60/10 |
| Example 25 | | | | | | | | | |
| Production | i | 280 | 0.2 | a | i | 300 | 0.2 | Uniaxial/Biaxial/Uniaxial | 10/60/10 |
| Example 26 | | | | | | | | | |
| Production | c | 700 | 0.1 | c | c | 750 | 0.1 | Unstretched/Biaxial/Unstretched | 20/60/20 |
| Example 27 | | | | | | | | | |
| Production | e | 160 | 0.2 | a | d | 900 | 0.2 | Uniaxial/Biaxial/Uniaxial | 10/60/10 |
| Example 28 | | | | | | | | | |
| Production | a | 1600 | 0.6 | a | a | 1600 | 0.6 | Uniaxial/Biaxial/Uniaxial | 10/60/10 |
| Example 29 | | | | | | | | | |
| Production | c | 1450 | 0.1 | a | c | 1500 | 0.1 | Uniaxial/Biaxial/Uniaxial | 10/60/10 |
| Example 30 | | | | | | | | | |
| Production | e | 150 | 0.2 | a | e | 180 | 0.2 | Uniaxial/Biaxial/Uniaxial | 10/60/10 |
| Example 31 | | | | | | | | | |
| Production | e | 150 | 0.2 | a | e | 170 | 0.2 | Uniaxial/Biaxial/Uniaxial | 10/60/10 |
| Example 32 | | | | | | | | | |
| Production | e | 150 | 0.2 | a | e | 180 | 0.2 | Uniaxial/Biaxial/Uniaxial | 10/60/10 |
| Example 33 | | | | | | | | | |
| Production | e | 160 | 0.2 | a | d | 880 | 0.2 | Uniaxial/Biaxial/Uniaxial | 10/60/10 |
| Example 34 | | | | | | | | | |
| Production | e | 160 | 0.2 | a | d | 880 | 0.2 | Uniaxial/Biaxial/Uniaxial | 10/60/10 |
| Example 35 | | | | | | | | | |
| Production | e | 160 | 0.2 | a | d | 880 | 0.2 | Uniaxial/Biaxial/Uniaxial | 10/60/10 |
| Example 36 | | | | | | | | | |
| Production | e | 160 | 0.2 | a | d | 880 | 0.2 | Uniaxial/Biaxial/Uniaxial | 10/60/10 |
| Example 37 | | | | | | | | | |

### Production of Recording Paper

### Production Example 21 of Recording Paper

After corona discharge treatment was applied to both sides of the laminated resin film obtained in Production Example 1 under conditions of 30 W·minute/m², the coating solution for forming a resin coating (a) prepared in Preparation Example 1 was applied thereto using a roll coater so that the thickness after drying of each surface was 0.03 μm. The coating layer was dried in an oven at 60° C. to form a resin coating, thereby obtaining a recording paper produced by Production Example 21 of the recording paper.

### Production Examples 22 to 37 of Recording Paper

Recording papers as the recording papers of Production Examples 22 to 37 were obtained in the same manner as in Production Example 21 of the recording paper except that the laminated resin film and the resin coating were changed as shown in Table 7 below in Production Example 21 of the recording paper.

Table 7 below shows Production Examples 21 to 37 of the recording paper.

TABLE 7
Recording paper

| | Laminated resin film | | | | | | | | | Resin coating | |
|---|---|---|---|---|---|---|---|---|---|---|---|
| | | | | | | | | | | Coating | |
| | | | | | | | | | | solution | |
| | First underlayer | | | | Second underlayer | | | | | for | |
| | Resin | | Surface | Core layer | | | Surface | | | forming | |
| | compo- | Modulus | roughness | Resin | Resin | Modulus | roughness | | Thickness | resin | Thickness |
| | sition | [MPa] | [μm] | composition | composition | [MPa] | [μm] | Stretch | [μm] | coating | [μm] |
| Production | e | 160 | 0.2 | a | d | 880 | 0.2 | Uniaxial/Biaxial/ | 10/60/10 | (a) | 0.03 |
| Example 21 | | | | | | | | Uniaxial | | | |
| Production | e | 140 | 0.2 | a | e | 150 | 0.2 | Uniaxial/Biaxial/ | 10/60/10 | (b) | 0.03 |
| Example 22 | | | | | | | | Uniaxial | | | |
| Production | r | 410 | 0.2 | a | f | 400 | 0.2 | Uniaxial/Biaxial/ | 10/60/10 | (c) | 0.30 |
| Example 23 | | | | | | | | Uniaxial | | | |
| Production | g | 1050 | 0.1 | a | g | 1000 | 0.1 | Uniaxial/Biaxial/ | 10/60/10 | (b) | 0.03 |
| Example 24 | | | | | | | | Uniaxial | | | |
| Production | h | 540 | 0.1 | a | h | 520 | 0.1 | Uniaxial/Biaxial/ | 10/60/10 | (c) | 0.30 |
| Example 25 | | | | | | | | Uniaxial | | | |
| Production | i | 280 | 0.2 | a | i | 300 | 0.2 | Uniaxial/Biaxial/ | 10/60/10 | (b) | 0.03 |
| Example 26 | | | | | | | | Uniaxial | | | |
| Production | c | 700 | 0.1 | c | c | 750 | 0.1 | Unstretched/Biaxial/ | 20/60/20 | (a) | 0.03 |
| Example 27 | | | | | | | | Unstretched | | | |
| Production | e | 160 | 0.2 | a | d | 900 | 0.2 | Uniaxial/Biaxial/ | 10/60/10 | (a) | 3.00 |
| Example 28 | | | | | | | | Uniaxial | | | |
| Production | a | 1600 | 0.6 | a | a | 1600 | 0.6 | Uniaxial/Biaxial/ | 10/60/10 | (b) | 0.03 |
| Example 29 | | | | | | | | Uniaxial | | | |
| Production | c | 1450 | 0.1 | a | c | 1500 | 0.1 | Uniaxial/Biaxial/ | 10/60/10 | (b) | 0.03 |
| Example 30 | | | | | | | | Uniaxial | | | |
| Production | e | 150 | 0.2 | a | e | 180 | 0.2 | Uniaxial/Biaxial/ | 10/60/10 | (d) | 0.35 |
| Example 31 | | | | | | | | Uniaxial | | | |
| Production | e | 150 | 0.2 | a | e | 170 | 0.2 | Uniaxial/Biaxial/ | 10/60/10 | (e) | 0.30 |
| Example 32 | | | | | | | | Uniaxial | | | |
| Production | e | 150 | 0.2 | a | e | 180 | 0.2 | Uniaxial/Biaxial/ | 10/60/10 | (f) | 0.30 |
| Example 33 | | | | | | | | Uniaxial | | | |
| Production | e | 160 | 0.2 | a | d | 880 | 0.2 | Uniaxial/Biaxial/ | 10/60/10 | (g) | 0.03 |
| Example 34 | | | | | | | | Uniaxial | | | |
| Production | e | 160 | 0.2 | a | d | 880 | 0.2 | Uniaxial/Biaxial/ | 10/60/10 | (h) | 0.02 |
| Example 35 | | | | | | | | Uniaxial | | | |
| Production | e | 160 | 0.2 | a | d | 880 | 0.2 | Uniaxial/Biaxial/ | 10/60/10 | (i) | 0.02 |
| Example 36 | | | | | | | | Uniaxial | | | |
| Production | e | 160 | 0.2 | a | d | 880 | 0.2 | Uniaxial/Biaxial/ | 10/60/10 | (j) | 0.02 |
| Example 37 | | | | | | | | Uniaxial | | | |

### Production Examples of Adhesive Label

### Example 21

Using glassine paper treated with silicone (G7B, available from Oji Tac Co., Ltd.) as a release sheet, a mixed solution of a solvent-type acrylic pressure-sensitive adhesive (ORIBAIN BPS1109, available from TOYOCHEM CO., LTD.), an isocyanate-type crosslinking agent (ORIBAIN BHS8515, available from TOYOCHEM CO., LTD.), and toluene at a ratio of 100:3:45 was applied onto the silicone-treated surface of the glassine paper with a comma coater so that the grammage after drying was 25 g/m², followed by drying, to form an adhesive layer.

Then, the second underlayer side of the laminated resin film was laminated on the adhesive layer so as to be in contact therewith, the recording paper obtained in Production Example 21 of the recording paper and the glassine paper were pressure-bonded with a press roll, to form an adhesive layer on the recording paper, thereby obtaining the adhesive label of Example 21.

### Examples 22 to 31 and Comparative Examples 21 to 26

The adhesive labels of Examples 22 to 31 and Comparative Examples 21 to 26 were obtained in the same manner as Example 21 except that the recording paper obtained in Production Example 21 was changed to the recording papers obtained in Production Examples 22 to 37 in Example 21, as shown in Table 8.

### (Evaluation)

The adhesive labels obtained in Examples 21 to 31 and Comparative Examples 21 to 26 were evaluated, as follows, by the same method as for the aforementioned recording paper. However, printing was performed on the surface (resin coating surface) on the opposite side to the adhesive layer-formed surface of each adhesive label.

<Anti-blocking property 1>
<Anti-blocking property 2>
<Toner transferability>
<Toner adhesion>
<Scratch resistance: wet A>
<Scratch resistance: wet B>
<Change in gloss in printing>

Further, the adhesive labels obtained in Examples 21 to 31 and Comparative Examples 21 to 26 were evaluated for laminateability and adhesive residue by the following methods.

### <Laminateability>

On the printed surface of the adhesive label printed by the aforementioned procedure, a PET film was laminated using a cold lamination technique. Here, the PET film used had a pressure-sensitive adhesive formed on one side (product name PROSHIELD Cold UV-HG50, available from JetGraph. Co., Ltd.), and lamination was performed by stacking the adhesive surface of the PET film on the printed surface of the adhesive label at 23° C., followed by pressure bonding. Then, these were immersed in water at 23° C. for 24 hours. Moisture on the surface taken out of water was lightly wiped off with a waste cloth, and the PET film was gradually peeled off by hand 5 minutes later. The laminateability was evaluated based on the following criteria by visually observing the state of the printed surface after peeling the PET film.

Good: No toner peeling observed
Fair: 30% or more and less than 50% of toner in PET film-peeled portion transferred to PET film side (lower limit of practical use)
Poor: 50% or more of toner in PET film-peeled portion transferred to PET film side (not suitable for practical use)

### <Adhesive Residue>

The release sheet of the adhesive label was peeled off, and the surface of the adhesive layer was attached to a transparent and highly smooth glass plate and closely contacted sufficiently by rubbing it three times with a finger. Then, the glass plate in close contact with the adhesive label was heated in an environment at a temperature of 40° C. for 24 hours and then immersed in water at 23° C. for 24 hours. Then, it was taken out of the water, and moisture was lightly wiped off with a waste cloth. 5 minutes later, the adhesive label in close contact was peeled off by hand in the 180-degree direction at a speed of 300m/min. The haze in the portion of the glass plate where the adhesive label was peeled off was measured with a haze meter (model name: NDH2000, available from NIPPON DENSHOKU INDUSTRIES CO., LTD.) according to JIS K7136: 2000. From the difference between the measured haze and the haze of a solid glass plate, the adhesive residue of the pressure-sensitive adhesive was determined based on the following criteria.

Good: Haze difference of less than 5%
Fair: Haze difference of 5% or more and less than 10% (lower limit of practical use)
Poor: Haze difference of 10% or more (not suitable for practical use)

Table 8 below shows the evaluation results of the adhesive labels obtained in Examples 21 to 31 and Comparative Examples 21 to 26.

TABLE 8

| | | | | | | | | | | Suitability |
|---|---|---|---|---|---|---|---|---|---|---|
| | | | | Printability | | | | | | as adhesive |
| | | | | | | | | Change in | | label |
| Adhesive | | Anti-blocking | Anti-blocking | Toner | Toner | Scratch resistance | | gloss in | | Adhesive |
| label | Recording paper | property 1 | property 2 | transferability | adhesion | Wet A | Wet B | printing | Laminateability | residue |
| Example 21 | Production Example 21 | Good | Good | Good | Good | Good | Good | Good | Good | Good |
| Example 22 | Production Example 22 | Fair | Good | Good | Good | Good | Good | Good | Good | Good |
| Example 23 | Production Example 23 | Fair | Fair | Fair | Good | Good | Good | Good | Good | Good |
| Example 24 | Production Example 24 | Fair | Good | Good | Good | Good | Good | Good | Good | Good |
| Example 25 | Production Example 25 | Good | Good | Fair | Good | Good | Good | Good | Good | Good |
| Example 26 | Production Example 26 | Fair | Good | Good | Good | Good | Good | Good | Good | Good |
| Example 27 | Production Example 27 | Good | Good | Good | Good | Good | Good | Good | Good | Good |
| Example 28 | Production Example 28 | Good | Good | Good | Good | Good | Good | Fair | Good | Good |
| Example 29 | Production Example 34 | Good | Good | Good | Good | Good | Good | Good | Good | Good |
| Example 30 | Production Example 35 | Good | Good | Good | Good | Good | Good | Good | Good | Good |
| Example 31 | Production Example 36 | Good | Good | Good | Fair | Good | Good | Good | Good | Good |
| Comparative | Production Example 29 | Fair | Good | Good | Fair | Good | Fair | Good | Poor | Poor |
| Example 21 | | | | | | | | | | |
| Comparative | Production Example 30 | Fair | Good | Good | Fair | Good | Poor | Good | Poor | Poor |
| Example 22 | | | | | | | | | | |
| Comparative | Production Example 31 | Fair | Poor | Good | Good | Good | Fair | Poor | Poor | Poor |
| Example 23 | | | | | | | | | | |
| Comparative | Production Example 32 | Good | Good | Poor | Poor | Fair | Poor | Fair | Fair | Fair |
| Example 24 | | | | | | | | | | |
| Comparative | Production Example 33 | Good | Good | Poor | Good | Poor | Poor | Good | Fair | Fair |
| Example 25 | | | | | | | | | | |
| Comparative | Production Example 37 | Good | Good | Good | Poor | Good | Good | Good | Poor | Poor |
| Example 26 | | | | | | | | | | |

As is obvious from Table 8, it was confirmed that the adhesive labels of Examples 21 to 31 had good printability in all of toner transferability, toner adhesion, and scratch resistance even in the case where printing was performed by the wet electrophotographic printing system using liquid toner. As for the toner adhesion, good results were obtained even under wet conditions, and the water resistant adhesion was particularly high.

Further, it was confirmed that the adhesive labels of Examples 21 to 31 were adhesive labels without adhesive residue, blocking, and change in paper quality after printing.

### Examples of In-Mold Label

### Preparation of Resin Composition

A resin composition (j) below was prepared in addition to the aforementioned resin compositions (a) to (i).

### Preparation of Resin Composition (j)

The resin composition (j) composed of 30 parts by mass of propylene-ethylene random copolymer (product name: NOVATEC PP FW4B, available from Japan Polypropylene Corporation, MFR (230° C., 2.16 kg load): 6.5 g/10 minutes, melting point: 140° C.) and 70 parts by mass of long-chain low-density polyethylene (product name: NOVATEC LL UF240, available from Japan Polyethylene Corporation, MFR (190° C., 2.16 kg load): 2.1 g/10 minutes, melting point: 123° C.) was prepared.

Table 9 below shows the structural components of the resin compositions (a) and (c) to (j) used in the following Examples and Comparative Examples.

TABLE 9

| | Resin composition: Content ratio (parts by mass) | | | | | | | | |
|---|---|---|---|---|---|---|---|---|---|
| Contents | a | c | d | e | f | g | h | i | j |
| Propylene homopolymer (product name: NOVATEC PP FY4, | 80 | 100 | | | | 80 | 50 | 20 | |
| available from Japan Polypropylene Corporation, MFR ((230° C., | | | | | | | | | |
| 2.16 kg load): 5 g/10 min, melting point: 165° C.) | | | | | | | | | |
| Propylene-ethylene random copolymer (product name: | | | 100 | | | | | | 30 |
| NOVATEC PP FW4B, available from Japan Polypropylene | | | | | | | | | |
| Corporation, MFR (230° C., 2.16 kg load): 6.5 g/10 min, melting | | | | | | | | | |
| point: 140° C.) | | | | | | | | | |
| Olefin-type elastomer (product name: TAFMER PN PN-3560, | | | | 100 | | 20 | 50 | 80 | |
| available from Mitsui Chemicals, Inc., MFR (230° C., 2.16 kg | | | | | | | | | |
| load): 6 g/10 min, melting point: 160° C.) | | | | | | | | | |
| Long-chain low-density polyethylene (product name: | | | | | 100 | | | | 70 |
| NOVATEC LL UF240, available from Japan Polyethylene | | | | | | | | | |
| Corporation, MFR (190° C., 2.16 kg load): 2.1 g/10 min, melting | | | | | | | | | |
| point: 123° C.) | | | | | | | | | |
| Heavy calcium carbonate (product name: Softon 1800, available | 20 | | | | | | | | |
| from BIHOKU FUNKA KOGYO CO., LTD., average particle | | | | | | | | | |
| size: 1.2 μm) | | | | | | | | | |

### Production of Laminated Resin Film with Heat Sealing (HS) Layer

### Production Example 41 of Laminated Resin Film with HS Layer

The resin composition (a) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group, to obtain a uniaxially stretched sheet. Then, the resin composition (d) was melt-kneaded in an extruder set to 250° C., then extruded in the form of a sheet, and laminated on one surface of the aforementioned uniaxially stretched sheet, and the resin composition (f) was melt-kneaded in an extruder set to 250° C., then extruded in the form of a sheet, and laminated on the other side of the aforementioned uniaxially stretched sheet at the same time. The laminate was guided between a #150-wire gravure-embossed metal cooling roll and a matte rubber roll. While clamping the two between the metal cooling roll and the matte rubber roll to be bonded, the embossed pattern was transferred to the thermoplastic resin side, followed by cooling to room temperature with the cooling roll, to obtain a three-layer laminated sheet in which a layer formed using the resin composition (d), a layer formed using the resin composition (a), and a layer formed using the resin composition (f) were laminated in this order.

The three-layer laminated sheet obtained was cooled to 60° C., heated to about 150° C. using a tenter oven, stretched 8.5 times in the transverse direction, and then further heated to 160° C. for heat treatment. Then, after cooling to 60° C., the ear parts were slit, to obtain a laminated resin film with HS layer with each layer having a resin composition (d/a/f), the total thickness of layers of 80 μm, each layer having a thickness (15 μm/60 μm/5 μm), and each layer having the number of stretched axes (uniaxial/biaxial/uniaxial). In the laminated resin film with HS layer obtained, the layer formed using the resin composition (f) corresponds to the heat sealing layer, the layer formed using the resin composition (d) corresponds to the underlayer, and the layer formed using resin composition (a) corresponds to the substrate.

### Production Examples 42 to 46 and 48 to 58 of Laminated Resin Film with HS Layer

The laminated resin films with HS layer of Production Examples 42 to 46 and 48 to 58 was obtained in the same manner as in Production Example 41 of the laminated resin film with HS layer except that each layer was changed as shown in Table 10 below in Production Example 41.

### Production Example 47 of Laminated Resin Film with HS Layer

The resin composition (a) was melt-kneaded in an extruder set to 230° C., then supplied to an extrusion die set to 250° C., and extruded in the form of a sheet, and the sheet was cooled to 60° C. with a cooling device, to obtain an unstretched sheet. The unstretched sheet was heated to 135° C. and stretched 5 times in the longitudinal direction using the difference in peripheral speed in a roll group, to obtain a uniaxially stretched sheet. Then, the uniaxially stretched sheet was cooled to 60° C., heated to about 150° C. using a tenter oven, stretched 8.5 times in the transverse direction, and then further heated to 160° C. for heat treatment. Then, after cooling to 60° C., the ear parts were slit, to obtain a biaxially stretched sheet with a thickness of 60 μm.

Meanwhile, the resin composition (c) was melt-kneaded in an extruder set to 250° C., then extruded in the form of a sheet, and laminated on one surface of the aforementioned biaxially stretched sheet. Concurrently, the resin composition (f) was melt-kneaded in an extruder set to 250° C., then extruded in the form of a sheet, and laminated on the other side of the aforementioned biaxially stretched sheet. The laminate was guided between a #150-wire gravure-embossed metal cooling roll and a matte rubber roll. While clamping the two between the metal cooling roll and the matte rubber roll to be bonded, the embossed pattern was transferred to the thermoplastic resin side, followed by cooling to room temperature with the cooling roll, to obtain a three-layer laminated sheet. Then, after cooling to 60° C., the ear parts were slit, to obtain a laminated resin film with HS layer with each layer having a resin composition (c/a/f), the total thickness of layers of 100 μm, each layer having a thickness (20 μm/60 μm/20 μm), and each layer having the number of stretched axes (unstretched/biaxial/unstretched).

### Production of In-Mold Label

### Example 41

The surface of the underlayer (that is, the layer formed using the resin composition (d)) of the aforementioned laminated resin film with HS layer of Production Example 41 was subjected to corona discharge treatment under the condition of 30 W·minute/m², and then the coating solution for forming a resin coating (a) prepared in Preparation Example 1 was applied onto the underlayer with a roll coater so that the thickness after drying was 0.03 μm. The coating layer was dried in an oven at 60° C. to form a resin coating, thereby obtaining the in-mold label of Example 41.

### Examples 42 to 47 and 49 to 52 and Comparative Examples 41 to 46

The in-mold labels of Examples 42 to 47 and 49 to 52 and Comparative Examples 41 to 46 were obtained in the same manner as in Example 41 except that the thickness of the coating solution for forming a resin coating and the resin coating was changed as shown in Table 10 below in Example 41.

### Example 48

Both sides of the laminated resin film with HS layer obtained in Production Example 48 were subjected to corona discharge treatment under the condition of 30 W·minute/m², and then the coating solution for forming a resin coating (a) prepared in Preparation Example 1 was applied thereto using a roll coater so that the thickness after drying of each surface was 0.03 μm. The coating layer was dried in an oven at 60° C. to form a resin coating on each of both sides of the laminated resin film, thereby obtaining the in-mold label of Example 48.

Table 10 below shows the configuration of the in-mold label in each of Examples and Comparative Examples. The number of stretched axes and the thickness in Table 10 are shown in the order of underlayer/substrate/heat sealing layer.

TABLE 10
In-mold label

| | | | | | | | | | Resin coating | | | |
|---|---|---|---|---|---|---|---|---|---|---|---|---|
| | | | | | | | | | Resin coating | | Resin coating | |
| Laminated resin film with HS layer | | | | | | | | | (on underlayer) | | (on heat scaling layer) | |
| | Underlayer | | | | Heat sealing layer | | | | Coating | | Coating | |
| | | Indentation | Surface | Substrate | | Surface | | | solution for | | solution for | |
| | Resin | modulus | roughness | Resin | Resin | roughness | | Thickness | forming resin | Thickness | forming resin | Thickness |
| | compositon | [MPa] | [μm] | compositon | compositon | [μm] | Number of stretched axes | [μm] | coating | [μm] | coating | [μm] |

| | | | | | | | | | | | | | |
|---|---|---|---|---|---|---|---|---|---|---|---|---|---|
| Ex. 41 | Production Example 41 | d | 900 | 0.05 | a | f | 2.0 | Uniaxial/Biaxial/Uniaxial | 15/60/5 | (a) | 0.03 | — | — |
| Ex. 42 | Production Example 42 | e | 140 | 0.2 | a | j | 1.0 | Uniaxial/Biaxial/Uniaxial | 15/60/5 | (b) | 0.03 | — | — |
| Ex. 43 | Production Example 43 | f | 410 | 0.1 | a | f | 2.2 | Uniaxial/Biaxial/Uniaxial | 15/60/5 | (c) | 0.30 | — | — |
| Ex. 44 | Production Example 44 | g | 1050 | 0.1 | a | f | 2.0 | Uniaxial/Biaxial/Uniaxial | 15/60/5 | (b) | 0.03 | — | — |
| Ex. 45 | Production Example 45 | h | 540 | 0.1 | a | f | 2.0 | Uniaxial/Biaxial/Uniaxial | 15/60/5 | (c) | 0.30 | — | — |
| Ex. 46 | Production Example 46 | i | 280 | 0.2 | a | f | 2.0 | Uniaxial/Biaxial/Uniaxial | 15/60/5 | (b) | 0.03 | — | — |
| Ex. 47 | Production Example 47 | c | 700 | 0.1 | a | f | 2.2 | Unstretched/Biaxial/Unstretched | 20/60/20 | (a) | 0.03 | — | — |
| Ex. 48 | Production Example 48 | d | 790 | 0.05 | a | f | 2.1 | Uniaxial/Biaxial/Uniaxial | 10/60/10 | (a) | 0.03 | (a) | 0.03 |
| Ex. 49 | Production Example 49 | d | 900 | 0.05 | a | f | 2 | Uniaxial/Biaxial/Uniaxial | 15/60/5 | (a) | 3.00 | — | — |
| Ex. 50 | Production Example 55 | d | 900 | 0.05 | a | f | 2 | Uniaxial/Biaxial/Uniaxial | 15/60/5 | (a) | 0.03 | — | — |
| Ex. 51 | Production Example 56 | d | 900 | 0.05 | a | f | 2 | Uniaxial/Biaxial/Uniaxial | 15/60/5 | (a) | 0.02 | — | — |
| Ex. 52 | Production Example 57 | d | 900 | 0.05 | a | f | 2 | Uniaxial/Biaxial/Uniaxial | 15/60/5 | (a) | 0.02 | — | — |
| Comp. | Production Example 50 | a | 1600 | 0.6 | a | f | 2.1 | Uniaxial/Biaxial/Uniaxial | 15/60/5 | (b) | 0.03 | — | — |
| Ex. 41 | | | | | | | | | | | | | |
| Comp. | Production Example 51 | c | 1450 | 0.1 | a | j | 1.0 | Uniaxial/Biaxial/Uniaxial | 15/60/5 | (b) | 0.03 | — | — |
| Ex. 42 | | | | | | | | | | | | | |
| Comp. | Production Example 52 | e | 150 | 0.2 | a | f | 2.0 | Uniaxial/Biaxial/Uniaxial | 15/60/5 | (d) | 0.35 | — | — |
| Ex. 43 | | | | | | | | | | | | | |
| Comp. | Production Example 53 | e | 150 | 0.2 | a | f | 2.0 | Uniaxial/Biaxial/Uniaxial | 15/60/5 | (e) | 0.30 | — | — |
| Ex. 44 | | | | | | | | | | | | | |
| Comp. | Production Example 54 | e | 140 | 0.2 | a | j | 1.0 | Uniaxial/Biaxial/Uniaxial | 15/60/5 | (f) | 0.03 | — | — |
| Ex. 45 | | | | | | | | | | | | | |
| Comp. | Production Example 58 | d | 900 | 0.05 | a | f | 2 | Uniaxial/Biaxial/Uniaxial | 15/60/5 | (a) | 0.02 | — | — |
| Ex. 46 | | | | | | | | | | | | | |

### Evaluation

The in-mold label obtained in each of Examples 41 to 52 and Comparative Examples 41 to 46 above was evaluated in the same manner as the aforementioned recording paper. However, printing was performed on the opposite surface to the heat sealing layer-formed surface of the in-mold label (resin coating surface).

<Anti-blocking property 1>
<Toner transferability>
<Toner adhesion>
<Scratch resistance: wet A>
<Scratch resistance: wet B>

The in-mold label obtained in each of Examples 41 to 52 and Comparative Examples 41 to 46 above was further evaluated for printability and suitability for in-mold molding by the following methods.

### <Toner Adhesion 2>

The in-mold labels after printing were each scratched in a grid pattern (width 10 mm, length 10 mm) at 1 mm intervals with a cutter, immersed in water at 23° C. for 24 hours, and then taken out of the water, and moisture was lightly wiped off with a waste cloth. 5 minutes after wiping, the adhesive surface of an adhesive tape (product name: Cellotape (R) CT-18, available from NICHIBAN CO., LTD.) was attached to the printed surface of the in-mold label and closely contacted sufficiently by rubbing it three times with a finger. After the adhesive label in close contact was peeled off by hand in the 180-degree direction at a speed of 300 m/min, the toner remaining proportion on the in-mold label was calculated with a compact general-purpose image analyzer (model name: LUZEX-AP, available from NIRECO CORPORATION). Specifically, an image obtained by capturing the printed surface was subjected to binarization, and the proportion of the area occupied by the toner was calculated as the remaining proportion. From the calculated toner remaining proportion, the toner adhesion was evaluated and ranked based on the following criteria.

Good: Toner remaining proportion of 80% or more
Fair: Toner remaining proportion of 50% or more and less than 80% (lower limit of practical use)
Poor: Toner remaining proportion of less than 50% (not suitable for practical use)

### <Scratch Resistance: Wet C>

The in-mold label after printing was immersed in ethanol at 23° C. for 24 hours, then taken out of ethanol, and lightly wiped off with a waste cloth. 5 minutes after wiping, it was set in a Gakushin-type dyeing friction fastness tester (device name: Type II friction tester, available from Suga Test Instruments Co., Ltd.), to conduct a friction test by rubbing 100 times with a white cotton cloth moistened with water under a load of 500 g. Based on the same criteria as in evaluation for Toner adhesion 2, the scratch resistance was evaluated from the toner remaining proportion on the recording paper after the friction test.

### <<Scratch Resistance: Wet Conditions D>>

The in-mold label after printing was immersed in a neutral detergent (product name: Cucute, available from Kao Corporation) at 23° C. for 24 hours, then taken out of the detergent, and lightly wiped off after the detergent was sufficiently washed away with water. 5 minutes after wiping, the friction test and evaluation were performed in the same manner as in Scratch resistance: wet C.

### <Formability>

The in-mold label after printing obtained in Examples 41 to 47 and 49 to 52, and Comparative Examples 41 to 46 was punched into a rectangle with a width of 60 mm and a length of 110 mm. The processed in-mold label was disposed on one side of blow forming dies capable of forming a bottle with a content of 400 mL so that the heat sealing layer faces the cavity side and fixed to the die by suction. Then, high-density polyethylene (product name “NOVATEC HD HB420R”, available from Japan Polyethylene Corporation, MFR (JIS K 7210: 1999)=0.2 g/10 minutes, melting peak temperature (JIS K 7121: 2012)=133° C., crystallization peak temperature (JIS K 7121: 2012)=115° C., density=0.956 g/cm³) was melted at 170° C. and extruded in the form of parison between the dies.

After the dies were closed, 4.2 kg/cm² of compressed air was supplied into the parison. The parison was expanded for 16 seconds and then closely contacted with the dies to form a container, and the parison and the label were fused. Then, the formed product was cooled within the dies, and the dies were opened to obtain a labeled container. At this time, the die cooling temperature was 20° C., and the shot cycle time was 34 seconds/time. The appearance of the container obtained was visually inspected and evaluated as follows.

Good: Firm adhesion with no label lifting visually observed
Fair: Firm adhesion with partial label lifting visually observed (lower limit of practical use)
Poor: Firm adhesion failed with label peeling or label part lifting observed in most (impractical)

Meanwhile, the in-mold label after printing obtained in Example 48 was punched into a rectangle with a width of 60 mmm and a length of 80 mm. The processed in-mold label was disposed inside forming dies of a stretch blow molding machine (device name: ASB-70DPH, NISSEI ASB MACHINE CO., LTD.) so that the heat sealing layer faces the cavity side and the dies were closed. The dies were controlled so that the surface temperature on the cavity side was within the range of 20 to 45° C. Meanwhile, a resin preform made of polyethylene terephthalate preheated to 100° C. was introduced between the dies, followed by stretch blow forming for 1 second under a blow pressure of 5 to 40 kg/cm². Then, after cooling for 15 seconds to 50° C., the dies were opened, to obtain an in-mold label-attached container. The appearance of the container obtained was evaluated in the same manner as the container obtained in Examples 41 to 47 and 49 to 52, and Comparative Examples 41 to 46 above.

### <Toner Adhesiveness 3>

The in-mold label surface of the labeled container obtained by the aforementioned method was scratched with a cutter, then immersed in water at 23° C. for 24 hours, and taken out of water. Moisture was lightly wiped off with a waste cloth, the adhesive surface of an adhesive tape (product name: Cellotape (R) CT-18, available from NICHIBAN CO., LTD.) was attached to the portion scratched with a cutter in a direction perpendicular to the scratch direction and closely contacted sufficiently by rubbing it three times with a finger. After the adhesive tape in close contact was peeled off by hand in the 180-degree direction at a speed of 300m/min, the toner remaining proportion on the in-mold label was calculated with a compact general-purpose image analyzer (model name: LUZEX-AP, available from NIRECO CORPORATION). From the calculated toner ink remaining proportion, the toner ink adhesion was evaluated and ranked based on the following criteria.

Good: Toner remaining proportion of 80% or more
Fair: Toner remaining proportion of 50% or more and less than 80% (lower limit of practical use)
Poor: Toner remaining proportion of less than 50% (not suitable for practical use)
<Change in Gloss after Forming>

The 75-degree specular glossiness of the white portion in the label part of the labeled hollow forming container obtained by the aforementioned method was measured according to JIS P 8142:1993, and the change in gloss after forming was determined from the difference from the glossiness of the recording paper not formed based on the following evaluation criteria.

Good: Glossiness difference of less than 5%
Fair: Glossiness difference of 5% or more and less than 10% (lower limit of practical use)
Poor: Glossiness difference of 10% or more (not suitable for practical use)

Table 11 and Table 12 below show the evaluation results.

TABLE 11

| | | Printability | | | | | | | |
|---|---|---|---|---|---|---|---|---|---|
| | | | | | | Scratch resistance | | | |
| | | | | | | | | | Wet D |
| | Laminated resin film | Anti-blocking | Toner | Toner | Toner | Wet A | Wet B | Wet C | Neutral |
| In-mold label | with HS layer | property 1 | transferability | adhesion | adhesion 2 | Water | Water | Ethanol | detergent |
| Example 41 | Production Example 41 | Good | Good | Good | Good | Good | Good | Good | Good |
| Example 42 | Production Example 42 | Fair | Good | Good | Good | Good | Good | Good | Good |
| Example 43 | Production Example 43 | Fair | Fair | Good | Good | Good | Good | Good | Fair |
| Example 44 | Production Example 44 | Fair | Good | Good | Good | Good | Good | Good | Good |
| Example 45 | Production Example 45 | Good | Fair | Good | Good | Good | Good | Good | Fair |
| Example 46 | Production Example 46 | Fair | Good | Good | Good | Good | Good | Good | Good |
| Example 47 | Production Example 47 | Good | Good | Good | Good | Good | Good | Good | Good |
| Example 48 | Production Example 48 | Good | Good | Good | Good | Good | Good | Good | Good |
| Example 49 | Production Example 49 | Good | Good | Good | Good | Good | Good | Good | Good |
| Example 50 | Production Example 55 | Good | Good | Good | Good | Good | Good | Good | Good |
| Example 51 | Production Example 56 | Good | Good | Good | Good | Good | Good | Good | Good |
| Example 52 | Production Example 57 | Good | Fair | Fair | Good | Good | Good | Good | Good |
| Comparative | Production Example 50 | Fair | Good | Fair | Fair | Good | Fair | Fair | Poor |
| Example 41 | | | | | | | | | |
| Comparative | Production Example 51 | Fair | Good | Fair | Poor | Good | Poor | Poor | Poor |
| Example 42 | | | | | | | | | |
| Comparative | Production Example 52 | Poor | Good | Good | Poor | Good | Fair | Fair | Poor |
| Example 43 | | | | | | | | | |
| Comparative | Production Example 53 | Fair | Fair | Poor | Poor | Fair | Poor | Poor | Poor |
| Example 44 | | | | | | | | | |
| Comparative | Production Example 54 | Good | Poor | Good | Good | Poor | Poor | Poor | Poor |
| Example 45 | | | | | | | | | |
| Comparative | Production Example 58 | Good | Poor | Poor | Good | Good | Good | Good | Good |
| Example 46 | | | | | | | | | |

TABLE 12

| | Laminated | | | | |
|---|---|---|---|---|---|
| | resin film | | Suitability for in-mold molding | | |
| | with HS | Formed | | Bottle | |
| Example | layer | container | Formability | adhesiveness | Change in gloss |
| Example 41 | Production | PE | Good | Good | Good |
| | Example 41 | | | | |
| Example 42 | Production | PE | Good | Good | Good |
| | Example 42 | | | | |
| Example 43 | Production | PE | Good | Good | Good |
| | Example 43 | | | | |
| Example 44 | Production | PE | Good | Good | Good |
| | Example 44 | | | | |
| Example 45 | Production | PE | Good | Good | Good |
| | Example 45 | | | | |
| Example 46 | Production | PE | Good | Good | Good |
| | Example 46 | | | | |
| Example 47 | Production | PE | Good | Good | Good |
| | Example 47 | | | | |
| Example 48 | Production | PET | Good | Good | Good |
| | Example 48 | | | | |
| Example 49 | Production | PE | Good | Good | Good |
| | Example 49 | | | | |
| Example 50 | Production | PE | Good | Good | Good |
| | Example 55 | | | | |
| Example 51 | Production | PE | Good | Good | Good |
| | Example 56 | | | | |
| Example 52 | Production | PE | Good | Good | Good |
| | Example 57 | | | | |
| Comparative | Production | PE | Good | Fair | Good |
| Example 41 | Example 50 | | | | |
| Comparative | Production | PE | Good | Poor | Good |
| Example 42 | Example 51 | | | | |
| Comparative | Production | PE | Good | Fair | Poor |
| Example 43 | Example 52 | | | | |
| Comparative | Production | PE | Good | Fair | Good |
| Example 44 | Example 53 | | | | |
| Comparative | Production | PE | Good | Good | Good |
| Example 45 | Example 54 | | | | |
| Comparative | Production | PE | Good | Poor | Good |
| Example 46 | Example 58 | | | | |

As shown in Table 11 and Table 12, it was confirmed that the in-mold labels of Examples had good printability in all of toner transferability, toner adhesion, and scratch resistance, and less blocking even in the case where printing was performed by the wet electrophotographic printing system using liquid toner. Since the results were good even under wet conditions, it is understood that the water resistance is particularly excellent. Further, during in-mold molding, excellent suitability for in-mold molding with sufficient adhesion to the container, little print peeling after in-mold molding, and little change in gloss were achieved. According to Example 48 provided with a resin coating also on the heat sealing layer side, it is understood that even a PET resin container showed high suitability for in-mold molding.

Meanwhile, according to the in-mold labels of Comparative Examples, although the toner transferability and the adhesion were achieved by containing olefin-type copolymer particles, the adhesion decreased under wet conditions, and blocking occurred. Further, a resin coating free from silane coupling agents and cationic water-soluble polymers could not achieve sufficient printability.

This application claims priority based on Japanese Patent Application Nos. 2019-003722, 2019-003851 and 2019-003775, which are Japanese patent applications filed on Jan. 11, 2019. All the contents of the applications shall be incorporated.

### INDUSTRIAL APPLICABILITY

Having not only excellent appearance and high adhesion between the substrate and the resin coating but also high adhesion, particularly, high water resistant adhesion to ink or toner in various printing systems, the recording paper of the present invention can be used widely as printing paper, poster paper, label paper, ink jet recording paper, heat-sensitive recording paper, thermal transfer receiving paper, pressure-sensitive transfer recording paper, electrophotographic recording paper, and the like.

Having not only excellent appearance and excellent adhesion between the substrate and the resin coating, but also high adhesion to ink or toner by various printing systems, particularly, high water resistant adhesion, the adhesive label of the present invention can be widely used for packaging or clothing display labels, tags, etc., as an adhesive label.

The in-mold label of the present invention can be widely used as a label provided on the surface of formed products subjected to in-mold molding, for example, resin containers such as PET resin containers and polyethylene resin containers, due to excellent adhesion ink or toner by various printing systems and high water resistant adhesion in addition to excellent appearance and excellent adhesion between the substrate and the resin coating. In particular, the in-mold label of the present invention is useful for containers of liquids such as beverages, cosmetics, and pharmaceutical products.

### REFERENCE SIGNS LIST

1: Substrate
2: Underlayer
3: Resin coating
4: Adhesive layer
5: Printed layer
6: Heat sealing layer
10: Recording paper
21: First underlayer
22: Second underlayer
31: Resin coating
32: Resin coating
40: Adhesive label
50a, 50b: In-mold label
101: Laminated resin film

1. A recording paper comprising:
a laminated resin film comprising a substrate composed of a thermoplastic resin film and an underlayer disposed on at least one side of the substrate and composed of a thermoplastic resin composition; and
a resin coating disposed facing the underlayer of the laminated resin film, wherein
the underlayer has an indentation modulus of 50 to 1200 MPa,
the resin coating contains a resin that is a reaction product of a cationic water-soluble polymer and a silane coupling agent,
a content of a silane coupling agent component is 15 to 60 parts by mass with respect to 100 parts by mass of the cationic water-soluble polymer component in the resin coating,
the resin coating is free from thermoplastic resin particles, and
a content of an inorganic filler is 9 parts by mass or less with respect to 100 parts by mass of the cationic water-soluble polymer component in the resin coating.

2. The recording paper according to claim 1, wherein the cationic water-soluble polymer is a (meth)acrylic polymer or an ethyleneimine polymer having an amino group or an ammonium salt structure.

3. The recording paper according to claim 2, wherein the (meth)acrylic polymer or the ethyleneimine polymer having an amino group or an ammonium salt structure has a primary to tertiary amino group or a primary to tertiary ammonium salt structure.

4. The recording paper according to claim 1, wherein the silane coupling agent is an epoxy silane coupling agent.

5. The recording paper according to claim 1, wherein the resin coating has a thickness of 0.01 to 5 μm.

6. A method for producing a recording paper, comprising:
applying an aqueous solution containing a cationic water-soluble polymer and a silane coupling agent and being free from thermoplastic resin particles with a content of an inorganic filler being 9 parts by mass or less with respect to 100 parts by mass of the cationic water-soluble polymer onto a laminated resin film, followed by drying to form a resin coating on the laminated resin film, wherein the laminated resin film comprises a substrate composed of a thermoplastic resin film and an underlayer composed of a thermoplastic resin composition and disposed on at least one side of the substrate.

7. An adhesive label comprising:
a laminated resin film comprising a substrate composed of a thermoplastic resin film, a first underlayer composed of a thermoplastic resin composition and disposed on one side of the substrate, and a second underlayer composed of a thermoplastic resin composition and disposed on the other side of the substrate;
a resin coating disposed facing the first underlayer of the laminated resin film;
a resin coating disposed facing the second underlayer of the laminated resin film; and
an adhesive layer disposed on a surface of the resin coating disposed facing the second underlayer on the opposite side of the second underlayer, wherein
the first and second underlayers each have an indentation modulus of 50 to 1200 MPa,
the resin coating contains a resin that is a reaction product of a cationic water-soluble polymer and a silane coupling agent,
a content of a silane coupling agent component is 15 to 60 parts by mass with respect to 100 parts by mass of the cationic water-soluble polymer component in the resin coating,
the resin coating is free from thermoplastic resin particles, and
a content of an inorganic filler is 9 parts by mass or less with respect to 100 parts by mass of the cationic water-soluble polymer component in the resin coating.

8. An in-mold label provided with a heat sealing layer on one side of a laminated resin film, wherein
the in-mold label comprises a resin coating provided on a surface of the laminated resin film on the opposite side of the heat sealing layer,
the laminated resin film comprises a substrate composed of a thermoplastic resin film and an underlayer composed of a thermoplastic resin composition and provided between the substrate and the resin coating,
the underlayer has an indentation modulus of 50 to 1200 MPa,
the resin coating contains a resin that is a reaction product of a cationic water-soluble polymer and a silane coupling agent,
a content of a silane coupling agent component is 15 to 60 parts by mass with respect to 100 parts by mass of the cationic water-soluble polymer component in the resin coating,
the resin coating is free from thermoplastic resin particles, and
a content of an inorganic filler is 9 parts by mass or less with respect to 100 parts by mass of the cationic water-soluble polymer component in the resin coating.

9. The in-mold label according to claim 8, further comprising a resin coating provided on a surface of the heat sealing layer on the opposite side of the laminated resin film, wherein
the resin coating contains a resin that is a reaction product of a cationic water-soluble polymer and a silane coupling agent,
a content of a silane coupling agent component is 15 to 60 parts by mass with respect to 100 parts by mass of the cationic water-soluble polymer component in the resin coating,
the resin coating is free from thermoplastic resin particles, and
a content of an inorganic filler is 9 parts by mass or less with respect to 100 parts by mass of the cationic water-soluble polymer component in the resin coating.

10. The method according to claim 6,
the underlayer has an indentation modulus of 50 to 1200 MPa.
